(19) United States
(12) Patent Application Publication
(10) Pub. No.: US 2026/0160566 A1
(43) Pub. Date: Jun. 11, 2026

(54) PREDICTION OF TRIP ENERGY REQUIRED FOR ELECTRIC VEHICLES

(71) Applicant: TOYOTA MOTOR ENGINEERING & MANUFACTURING NORTH AMERICA, INC., Plano, TX (US)

(72) Inventors: Shinhoon Kim, Ann Arbor, MI (US); Vishnu Prasaad Raghupathy, Canton, MI (US)

(73) Assignees: TOYOTA MOTOR ENGINEERING & MANUFACTURING NORTH AMERICA, INC., Plano, TX (US); TOYOTA JIDOSHA KABUSHIKI KAISHA, Toyota-shi (JP)

(21) Appl. No.: 18/976,911

(22) Filed: Dec. 11, 2024

(51) Int. Cl. G01C 21/34

(52) U.S. Cl. CPC G01C 21/3469; G01C 21/3492

(57) ABSTRACT

An end-to-end trip energy prediction approach for electric vehicles is directly derived from real-world driving data while maintaining manageable implementation complexity and computational cost. Machine-learning based models capture the variability of vehicle parameters through use of a vehicle energy and HVAC consumption models derived from the real-world data.

### TECHNICAL FIELD

The subject matter described herein relates generally to battery usage in electric vehicles (“EVs”) and, more particularly, to systems and methods which predict the trip energy required in EVs.

### BACKGROUND

Conventional EV routing system are used to calculate the battery energy required to complete a trip as determined by the navigation system's routing logic. However, such routing systems fail to take real-world vehicle, road and weather conditions into account. As a result, the predicted battery energy consumption can often be inaccurate.

### SUMMARY

The various embodiments described herein provide an end-to-end trip energy prediction approach, where a comprehensive vehicle energy model is directly derived from real-world customer driving data while maintaining manageable implementation complexity and computational cost. The machine-learning (“ML”) based models described herein capture the variability of vehicle parameters through use of a vehicle energy consumption model derived from the real-world data. The ML models also capture the variability of the vehicle's air-conditioning (“AC”) system through use of an AC consumption model derived from the real-world data. Further, the described ML models are simple enough to be executed in a vehicle navigation system. Last, the ML models consider a smaller number of evaluations compared to conventional approaches to make trip energy predictions over long-distance trips.

A generalized embodiment of the present disclosure provides a computer-implemented method to predict trip energy required for electric vehicles. The system obtains, via a user interface, a destination location of an electric vehicle. The system then calculates, using a ML model, energy required for the electric vehicle to arrive at the destination location. The ML model comprises an energy consumption model that predicts variability of electric vehicle parameters while being driven to the destination location. In addition, the ML model also includes an AC model that predicts variability of an AC system of the electric vehicle while being driven to the destination location.

An alternative general embodiment of the present disclosure provides a system to predict trip energy required for electric vehicles. The system includes a processor having a memory and configured to perform operations comprising: obtaining, via a user interface, a destination location of an electric vehicle; and calculating, using a ML model, energy required for the electric vehicle to arrive at the destination location. The ML model comprises an energy consumption model that predicts variability of electric vehicle parameters while being driven to the destination location. In addition, the ML model also includes an AC model that predicts variability of an AC system of the electric vehicle while being driven to the destination location.

In yet another embodiment, a non-transitory computer-readable storage medium is provided which stores instructions that, when executed by a computing system, cause the computing system to perform operations comprising: obtaining, via a user interface, a destination location of an electric vehicle; and calculating, using a ML model, energy required for the electric vehicle to arrive at the destination location. The ML model comprises an energy consumption model that predicts variability of electric vehicle parameters while being driven to the destination location. In addition, the ML model also includes an AC model that predicts variability of an AC system of the electric vehicle while being driven to the destination location.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of the system described herein, as defined in the claims, is provided in the following written description of various embodiments of the disclosure and illustrated in the accompanying drawings.

### BRIEF DESCRIPTION OF THE DRAWINGS

Illustrative embodiments of the present disclosure will be described with reference to the accompanying drawings, of which:

FIG. 1 is a diagrammatic illustration of a system to predict trip energy required for electric vehicles in accordance with at least one embodiment of the present disclosure.

FIG. 2 is a diagrammatic illustration, in a block-diagram form, of at least a portion of the vehicle system of FIG. 1, in accordance with at least one embodiment of the present disclosure.

FIG. 3 is a chart of raw time-series data showing the speed, trip_{cnt}, distance and SOC over time, according to certain illustrative embodiments of the present disclosure.

FIG. 4 illustrates the workflow for extraction and transformation of the raw time-series data of selected signals into position-based data, according to certain illustrative embodiments of the present disclosure.

FIG. 5 is a chart illustrating the application of Algorithm 2, where the average function is applied to the speed signal for driving distances of 2, 4, 8, and 16 miles.

FIG. 6 presents histograms illustrating the distribution of key columns in the final modeling dataframe, df_{fin}.

FIG. 7 illustrates one example of the trip energy prediction techniques provided herein where Algorithm 1 is used to calculate the total battery energy required to complete the trip driven by a company-owned vehicle.

FIG. 8 is a chart illustrating the process of aggregating the same driving trip using three different link distances: 4, 8 and 16 miles, according to certain illustrative embodiments of the present disclosure.

FIG. 9 illustrates a 3D input feature tensor having different aggregated results for varying link distances.

FIG. 10A is a chart showing input features known to influence energy consumption, according to certain illustrative embodiments of the present disclosure.

FIG. 10B is a chart providing more detail of the selection of input features, according to certain illustrative embodiments of the present disclosure.

FIG. 11 is a flow process flow showing an illustrative model training and validation process.

FIG. 12 shows the of the model training, validation, and testing, according to certain illustrative embodiments of the present disclosure.

FIG. 13 shows charts illustrating the evaluation of three exemplary methods under extreme weather and driving conditions in North America.

FIGS. 14 and 15 are charts showing prediction results aggregated by location (states and provinces) and season (spring and summer versus fall and winter) to highlight the impact of locality and seasonality on the different methods.

FIG. 16 which shows an example of the input tensor when some of the input features are not available.

FIG. 17 is a flow chart of a method to predict trip energy required for electric vehicles, according to certain illustrative embodiments of the present disclosure.

FIG. 18 is a schematic diagram of a processor circuit 1850, in accordance with at least one embodiment of the present disclosure.

### DETAILED DESCRIPTION

The present disclosure is generally directed to predicting trip energy required for electric vehicles during artificial intelligence-based ML models. In general, EV routing systems use predefined vehicle and AC energy consumption models to calculate the battery energy required to complete a trip, as determined by the navigation system's routing logic. These “predefined” models are models which are derived based on the first principles of energy consumption dynamics. The routing logic identifies the shortest or fastest route from the current location to the destination by considering various traffic and road attributes, such as traffic speed and speed limits, which are extracted from map and traffic databases. The selected route comprises multiple links, which are road segments with constant traffic and/or road attributes. The energy required to travel each link is evaluated by inputting the link attributes into the energy consumption models. The total trip energy is then calculated by summing the energy required for each individual link.

The trip energy prediction in the conventional approaches is not difficult to implement, provided that the various traffic, weather, and road input profiles, as well as the model parameters, are readily available. However, the simplicity of such approaches often results in inconsistent prediction performance, primarily due to the low fidelity (limited representation of actual energy consumption dynamics) of the vehicle and AC energy models used in the conventional approaches.

However, illustrative embodiments of the present disclosure described herein provide improvements over conventional approaches by introducing an end-to-end trip energy prediction approach, where a comprehensive vehicle energy model is directly derived from real-world user driving data while maintaining manageable implementation complexity and computational cost. The ML-based energy models described herein capture the variability of the vehicle parameters because the vehicle energy consumption model is directly identified from the real-world data, whereas the conventional technology uses predefined vehicle models. The ML-based energy model also captures the variability of the AC system because the AC energy consumption model is directly identified from the real-world data whereas the conventional technology uses predefined AC models. Further, the ML models described herein are simple enough to be executed in a navigation system, and the models consider a smaller number of evaluations compared to the conventional technology to make a trip energy prediction over a long-distance trip.

The illustrative systems described herein may be implemented as a process at least partially implemented on an in-cabin display, and operated by a control process executing on a local or remote processor that accepts user interaction inputs from a suitable user-interface and other control devices, and that is in communication with one or more user interaction mechanisms and sensors. In that regard, the control process performs certain specific operations in response to different inputs or selections made at different times, and/or in response to real-time or near-real-time data received from interaction mechanisms or sensor readings.

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. It is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

These descriptions are provided for exemplary purposes, and should not be considered to limit the scope of the vehicle system described herein. Certain features may be added, removed, or modified without departing from the spirit of the claimed subject matter.

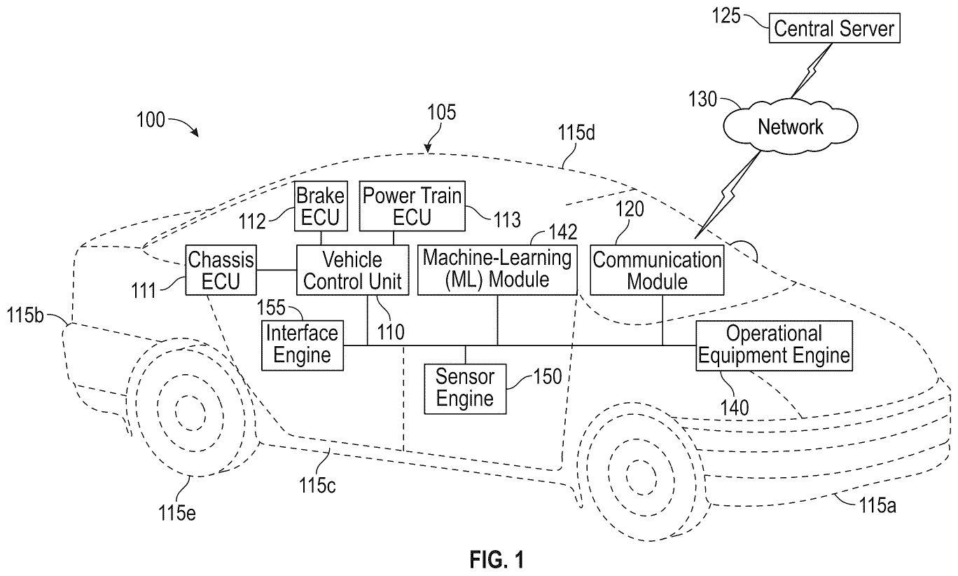

FIG. 1 is a diagrammatic illustration of a system to predict trip energy required for electric vehicles in accordance with at least one embodiment of the present disclosure. In an example, a system is referred to by the reference numeral 100 and includes a vehicle 105, such as an automobile, and a vehicle control unit 110 located on the vehicle 105. The vehicle 105 may include a front portion 115a (including a front bumper), a rear portion 115b (including a rear bumper), a right side portion 115c (including a right front quarter panel, a right front door, a right rear door, and a right rear quarter panel), a left side portion 115d (including a left front quarter panel, a left front door, a left rear door, and a left rear quarter panel), and wheels 115e.

A communication module 120 is operably coupled to, and adapted to be in communication with, the vehicle control unit 110. The communication module 120 is adapted to communicate wirelessly with a central server 125 via a network 130 (e.g., a 3G network, a 4G network, a 5G network, a Wi-Fi network, or the like). The central server 125 may provide information and services including but not limited to driving data from other customers/users on the network, location, mapping, weather, route or path, and topography information.

An operational equipment engine 140 is operably coupled to, and adapted to be in communication with, the vehicle control unit 110 and ML model module 142 which are utilized to perform the methods described herein. A sensor engine 150 is operably coupled to, and adapted to be in communication with, the vehicle control unit 110. The sensor engine 150 is adapted to monitor various components of, for example, the operational equipment engine 140 and one or more cameras in/on the vehicle (not shown), motion sensors, etc. as will be described in further detail below.

An interface engine 155 is operably coupled to, and adapted to be in communication with, the vehicle control unit 110. In addition to, or instead of, being operably coupled to, and adapted to be in communication with, the vehicle control unit 110, the communication module 120, the operational equipment engine 140, the sensor engine 150, and/or the interface engine 155 may be operably coupled to, and adapted to be in communication with, another of the components via wired or wireless communication (e.g., via an in-vehicle network). In some examples, the vehicle control unit 110 is adapted to communicate with the communication module 120, the operational equipment engine 140, the sensor engine 150, and the interface engine 155 to at least partially control the interaction of data with and between the various components of the vehicle system 100.

The term “engine” is meant herein to refer to an agent, instrument, or combination of either, or both, agents and instruments that may be associated to serve a purpose or accomplish a task—agents and instruments may include sensors, actuators, switches, relays, power plants, system wiring, computers, components of computers, programmable logic devices, microprocessors, software, software routines, software modules, communication equipment, networks, network services, and/or other elements and their equivalents that contribute to the purpose or task to be accomplished by the engine. Accordingly, some of the engines may be software modules or routines, while others of the engines may be hardware and/or equipment elements in communication with any or all of the vehicle control unit 110, the communication module 120, the network 130, or a central server 125.

In this example, the vehicle 105 also includes a chassis electronic control unit (ECU) 111 which controls elements of the vehicle's suspension system, a brake ECU 112 which controls the braking system or elements thereof, a power train ECU 113 (variously known as an engine ECU, power plant ECU, motor ECU, or transmission ECU) that controls elements of the motor 195 and drivetrain 200, and sensor engine 150.

A reader of ordinary skill in the art will understand that other components or arrangements of components may be found in a vehicle 105, and that the same general principles apply to, for example, electric vehicles and hybrid vehicles. For example, a power train ECU 113 may control both motor and transmission components. Alternatively, a separate motor ECU and transmission ECU may exist, or some functions of a motor ECU or transmission ECU may be performed by the VCU 110.

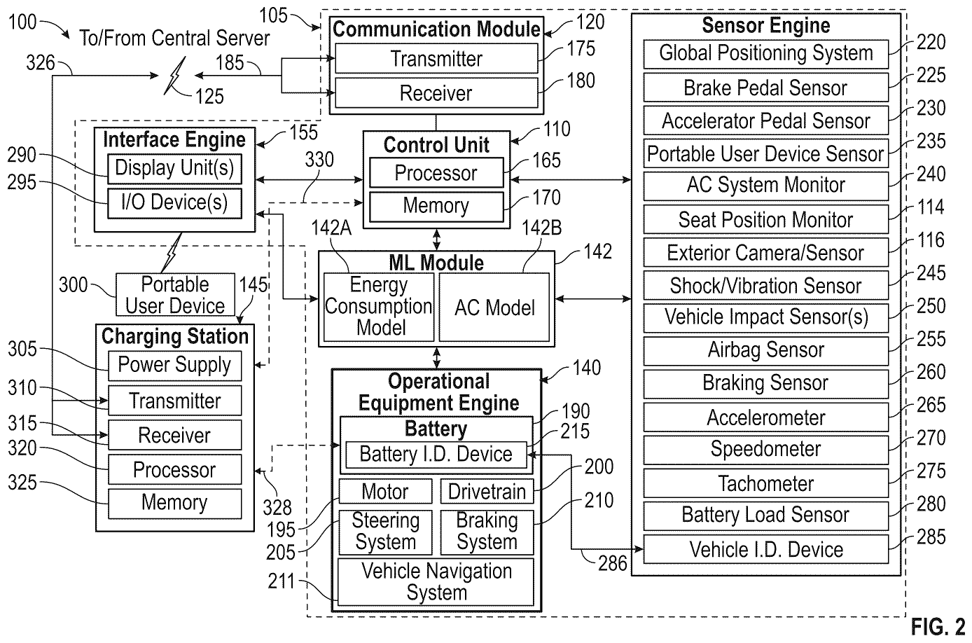

FIG. 2 is a diagrammatic illustration, in a block-diagram form, of at least a portion of the vehicle system 100 of FIG. 1, in accordance with at least one embodiment of the present disclosure. It is worth noting that the components of the vehicle 105 may be located either permanently or temporarily as a part of the vehicle 105. The vehicle control unit (VCU) 110 includes a processor 165 and a memory 170. In some examples, the communication module 120, which is operably coupled to, and adapted to be in communication with, the vehicle control unit 110, includes a transmitter 175 and a receiver 180. In some examples, one or the other of the transmitter 175 and the receiver 180 may be omitted according to the particular application for which the communication module 120 is to be used. In other examples, the transmitter 175 and receiver 180 are combined into a single transceiver that performs both transmitting and receiving functions.

In some examples, the operational equipment engine 140, which is operably coupled to, and adapted to be in communication with, the vehicle control unit 110, includes a plurality of devices configured to facilitate driving of the vehicle 105. In this regard, the operational equipment engine 140 may be designed to exchange communication with the vehicle control unit 110, so as to not only receive instructions, but to provide information on the operation of the operational equipment engine 140. For example, the operational equipment engine 140 may include a vehicle battery 190, a motor 195, a drivetrain 200, a steering system 205, a braking system 210, and a vehicle navigation system 211. In some vehicles, the vehicle battery 190 may provide electrical power to the motor 195 to drive the wheels 115e of the vehicle 105 via the drivetrain 200. In some examples, instead of or in addition to providing power to the motor 195 to drive the wheels 115e of the vehicle 105 via the drivetrain or transmission 200, the vehicle battery 190 provides electrical power to another component of the operational equipment engine 140, the vehicle control unit 110, the communication module 120, the sensor engine 150, the interface engine 155, or any combination thereof. In some examples, the vehicle battery 190 includes a battery identification device 215.

The battery identification device 215 is adapted to communicate with one or more components of the sensor engine 150, and stores data identifying the vehicle battery 190 such as, for example, manufacturing information (e.g., production date, production facility, etc.), battery characteristic(s) information, battery identification number information, electric vehicle compatibility information, or the like. In some embodiments, the motor is an internal combustion motor and the battery operates a starter.

In some examples, the sensor engine 150, which is operably coupled to, and adapted to be in communication with, the vehicle control unit 110, includes devices such as sensors, cameras, meters, detectors, or other devices configured to measure or sense a parameter related to a driving operation of the vehicle 105. For example, the sensor engine 150 may include a global positioning system 220 that can be used to determine road grade, a brake pedal sensor 225, an accelerator pedal sensor 230, a portable user device sensor 235 that can be used to determine when a certain driver or user is in the vicinity or inside vehicle 105, an AC system monitor 240 (to monitor air-conditioning use/settings), motion or their position within vehicle 105, a seat position monitor 114 used to control and monitor the position of the vehicle seats, a shock/vibration sensor 245, a vehicle impact sensor 250, an airbag sensor 255, a braking sensor 260, an accelerometer 265 (which may in some cases also serve as an inclinometer), a speedometer 270, a tachometer 275, a battery load sensor 280, a vehicle identification device 285, one or more exterior cameras or sensors 116 that can be used to monitor traffic and/or weather conditions around the vehicle or to determine when vehicle 105 approaches a parking space, or any combinations thereof. In some instances, traffic or weather patterns may be monitored from outside the vehicle and received from a server via a network.

Further, the sensors or other detection devices 116 may be configured to sense or detect activity, conditions, and circumstances in an area to which the device has access, e.g., ambient conditions, conditions within the vehicle cabin, etc. Sub-components of the sensor engine 150 may be deployed at any operational area where information on the driving of the vehicle 105 may occur. Some readings from the sensor engine 150 may be fed back to the vehicle control unit 110. Stored and reported performance data may include the sensed data, or may be derived, calculated, or inferred from sensed data. The vehicle control unit 110 may send signals to the sensor engine 150 to adjust the calibration or operating parameters of the sensor engine 150 in accordance with a control program in the vehicle control unit 110. The vehicle control unit 110 is adapted to receive and process performance data from the sensor engine 150 or from other suitable source(s), and to monitor, store (e.g., in the memory 170), and/or otherwise process (e.g., using the processor 165) the received performance data.

The braking sensor 260 is adapted to monitor usage of the vehicle 105's braking system 210 (e.g., an antilock braking system 210) and to communicate the braking information to the vehicle control unit 110. The accelerometer 265 is adapted to monitor acceleration of the vehicle 105 and to communicate the acceleration information to the vehicle control unit 110. The accelerometer 265 may be, for example, a two-axis accelerometer 265 or a three-axis accelerometer 265, and may also serve as an inclinometer or tilt sensor. In some examples, the accelerometer 265 is associated with an airbag of the vehicle 105 to trigger deployment of the airbag. The speedometer 270 is adapted to monitor speed of the vehicle 105 and to communicate the speed information to the vehicle control unit 110. In some examples, the speedometer 270 is associated with a display unit of the vehicle 105 such as, for example, a display unit of the interface engine 155, to provide a visual indication of vehicle speed to a driver of the vehicle 105. The tachometer 275 is adapted to monitor the working speed (e.g., in revolutions-per-minute) of the vehicle 105's motor 195 and to communicate the angular velocity information to the vehicle control unit 110. In some examples, the tachometer 275 is associated with a display unit of the vehicle 105 such as, for example, a display unit of the interface engine 155, to provide a visual indication of the motor 195's working speed to the driver of the vehicle 105. The battery load sensor 280 is adapted to monitor charging, discharging, and/or overcharging of the vehicle battery 190 and to communicate the charging, discharging, and/or overcharging information to the vehicle control unit 110.

In some examples, the vehicle identification device 285 stores data identifying the vehicle 105 such as, for example, manufacturing information (e.g., make, model, production date, production facility, etc.), vehicle characteristic(s) information, vehicle identification number (“VIN”) information, battery compatibility information, or the like. The vehicle identification device 285 is adapted to communicate with the battery identification device 215 (or vice versa), as indicated by arrow 286. In some examples, the vehicle identification device 285 and the battery identification device 215 may each communicate with the vehicle control unit 110.

In some examples, the interface engine 155, which is operably coupled to, and adapted to be in communication with, the vehicle control unit 110, includes at least one input and output device or system (user interaction mechanism) that enables a user to interact with the vehicle control unit 110, ML module 42, and the functions that the vehicle control unit 110 provides. Thus, in certain embodiments, the user enters a desired destination location via a user interaction mechanism communicably coupled to interface engine 155 and analyzed by ML module 142 to determine or predict the trip battery energy required for the electric vehicle to arrive at a given destination, as described herein.

In order to calculate the energy required for vehicle 105 to arrive at a desired destination location, ML model module 142 includes an energy consumption model 142A used to predict variability of vehicle energy consumption while vehicle 105 is being driven to a destination location. In addition, ML model module 142 includes an AC model 142B to predict variability of the AC system while being driven to the destination location.

Interface engine 155 may communicate with in-cabin occupants via a variety of display unit(s) 290 or I/O devices 295, also referred to as user interaction mechanisms. For example, the user interaction mechanisms can be a graphical user interface communicably coupled to navigation system 211 (e.g., display units 290), motion capture mechanism, microphone, display buttons, touchscreen or setting mechanism in the vehicle cabin. Examples of setting mechanisms can include air-conditioning settings, seat settings, volume settings and the like. Further, the user interaction mechanism can also be any interface which allows the user to communicate his or her intention with respect to vehicle charging activity. For example, an in-cabin display may prompt the user that the vehicle needs charging soon and ask if the user will charge soon (or otherwise solicit a response from the user). In response, the user could affirm his/her intention to charge/not charge the vehicle via a touch screen, sensory input or some other interaction mechanism. For example, touchscreen interactions would provide usability/behavioral tracking from the driver's interaction with the touchscreens. This data is saved locally or uploaded to the cloud and, thereafter, used to determine preferred or most effective communication variants (e.g., display locations in the vehicles, icon placement/size, etc.).

As previously mentioned, in some examples, a portable user device 300 belonging to an occupant of the vehicle 105 may be coupled to, and adapted to be in communication with, the interface engine 155 to assist in performing the methods described herein. For example, the portable user device 300 may be coupled to, and adapted to be in communication with, the interface engine 155 via the I/O device 295 (e.g., the USB port and/or the Bluetooth communication interface). In an example, the portable user device 300 is a handheld or otherwise portable device which is carried by a user who is a driver or a passenger on the vehicle 105. In addition, or instead, the portable user device 300 may be removably connectable to the vehicle 105, such as by temporarily attaching the portable user device 300 to the dash, a center console, a seatback, or another surface in the vehicle 105. In another example, the portable user device 300 may be permanently installed in the vehicle 105. In some examples, the portable user device 300 is, includes, or is part of one or more computing devices such as personal computers, personal digital assistants, key fobs, cellular devices, mobile telephones, wireless devices, handheld devices, laptops, audio devices, tablet computers, game consoles, cameras, and/or any other suitable devices. In several examples, the portable user device 300 is a smartphone such as, for example, an iPhone® by Apple Incorporated.

Further, control unit 110 is communicably coupled to a charging station 145 via communication link 330 to charge the vehicle battery 190, in the event of a hybrid or EV. Charging station 145 is communicably coupled to operational equipment engine 140 via a communication link 328. The charging station 145 may be any suitable charging station having a power supply 305, transmitter 310, receiver 315, processor 320 and memory 325 to perform the necessary charging, monitoring of charge status and communication processes. Charging station 145 communicates with the central server via communication link 326.

A reader of ordinary skill in the art will understand that other components or arrangements of components may be found in a vehicle 105, and that may of the same general principles apply to electric vehicles, internal combustion vehicles, and hybrid vehicles.

As previously mentioned, embodiments of the present disclosure provide end-to-end vehicle energy models derived directly from customer driving data, along with efficient calculation techniques to enable accurate energy predictions for long-distance trips accounting for the current and future vehicle, road and weather conditions. The illustrative machine-learning based trip energy prediction models are developed using three generalized steps: first, modeling data preparation with data augmentation that enables robust trip energy prediction models; second, training the models using a recurrent neural network (“RNN”), and; third, evaluating the models. A more detailed description of the trip energy prediction models described herein is provided below.

An EV routing feature as described herein in a navigation system is an essential tool for optimizing long road trips by minimizing the number of charging sessions enroute to destinations. EV routing features are designed to provide accurate and realistic estimates of the electric driving range, considering the current battery state of charge (SOC) as well as current and future weather and traffic conditions. This is an improvement over the range estimates shown on a vehicle's dashboard, typically calculated based on the current SOC and historical driving efficiencies stored in an electronic control unit (ECU). The EV routing feature described herein enhances existing navigation route optimizations by calculating the required battery energy for the selected shortest or fastest routes to a destination. The illustrative embodiments use predefined vehicle energy models that account for traffic, road, and weather attributes, such as speed limits, traffic speed, elevation gain, and ambient temperature, along the selected routes. Additionally, the vehicle energy models can be integrated into route optimizations to provide a comprehensive EV routing solution, suggesting routes based on the driver's preferences, such as energy-efficient or time-efficient routes.

Below, this disclosure will address shortcomings of conventional EV routing features, where the vehicle energy models do not accurately represent real-world energy consumption due to varying road, weather, and air conditioning (AC) conditions. Illustrative embodiments of the present disclosure provide a state of-the-art distributed data processing platform utilized to convert and enhance the petabyte-scale worth of raw time-series data into position-based data suitable for model development. Illustrative embodiments described herein then propose methods for training end-to-end multi-input vehicle energy models directly from this position-based data, along with efficient calculation schemes to enable accurate energy predictions for long-distance trips. The proposed methods were validated with real-world data and demonstrated superior performance compared to two benchmark EV routing solutions currently available.

A traction battery pack is the heaviest and most expensive individual component in an EV. The battery pack serves as the primary energy source for powering the electric motors that propel the vehicle while maintaining its designed operating temperature to ensure its health and longevity. To ensure a comfortable driving experience regardless of weather or seasonal conditions, the cabin's AC system is also powered by the battery pack to maintain desirable ambient conditions set by the passengers. While higher-priced battery EVs generally provide an adequate driving range compared to gasoline powered vehicles, more budget-friendly EVs often have a limited range due to the high cost associated with sourcing and installing a larger battery pack. Consequently, manufacturers of battery EVs must carefully balance power (acceleration), energy (driving range), and cost when developing an economical EV that performs well under the diverse real-world driving and weather conditions across North America.

Sensitivity studies have been conducted on how environmental factors—such as wind, road rolling resistance, and ambient temperature—affect EV energy consumption, demonstrating their impact on changes in EV range. The studies provided real-world driving data for the Tesla Model 3 collected from customers using abetterrouteplanner.com, demonstrating that wind conditions significantly influence energy consumption. Specifically, a direct headwind and a crosswind of 10 m/s increased the consumption of the Model 3 by 19% and 8%, respectively. Another study conducted detailed experimentation involving two semi-trailer trucks, each equipped with anemometers on the front to measure the impact of headwind on fuel consumption under various traffic conditions. This study found the trailing truck achieved more than 10% fuel savings when following the lead truck at a distance of less than 1 second. In this context, an EV routing feature in navigation systems becomes crucial. Such features assist EV drivers in maximizing range performance and enhancing the driving experience by preemptively accounting for current and future traffic, weather, and road conditions along their route.

In one example, an EV routing system uses standard vehicle and AC energy consumption models to calculate the battery energy required to complete a trip, as determined by the navigation system's routing logic. The routing logic identifies the shortest or fastest route from the current location to the destination by considering various traffic and road attributes, such as traffic speed and speed limits, which are extracted from map and traffic databases. The selected route comprises multiple links, which are road segments with constant traffic and road attributes. Each link has representative road and weather information, such as speed, distance, elevations gains, etc. The energy required to travel each link is evaluated by inputting the link attributes into the energy consumption models. The total trip energy is then calculated by summing the energy required for each individual link, as summarized in Algorithm 1 described below. Commercial map and navigation providers, such as HERE Maps and Mapbox, offer EV routing features as add-ons to their navigation services. These features are based on algorithms similar to the one described below:

Algorithm 1 Calculation of Battery Energy Required to
Complete a Trip

```
Input: Speed profile of the trip v(k) where k denotes a link k
    from 0 ... Nₗᵢₙₖ; Elevation gain profile Δz(k); Link dis-
    tance profile d(k); Ambient temperature profile T_{amb}(k);
    AC user setting profiles u_{AC}(A); Road load coefficients,
    vehicle mass, powertrain efficiencies, A, B, C, Mη_{P}, η_{R};
    Cabin and battery AC consumption models f_{cab,} f_{bat};
    Energy to ΔSOC model f_{soc}.
Output: Eₜᵣᵢₚ, ΔSOC
    Initialisation:
  1: Eₜᵣᵢₚ = 0
  2: for k = 0 to Nₗᵢₙₖ do
  $\begin{matrix}3 : {E}_{driving} += ( A + Bv ( k ) + {Cv ( k )}^{2} ) d ( k ) {η}_{p}^{- 1} & + \\ \{ \begin{matrix}Mg Δ z ( k ) {η}_{p}^{- 1} , & if Δ z ( k ) \geq 0 \\ Mg Δ z ( k ) {η}_{R} , & otherwise\end{matrix} & + \\ \{ \begin{matrix}\frac{1}{2} M ( {v ( k )}^{2} - {v ( k - 1 )}^{2} ) {η}_{p}^{- 1} , & if v ( k ) \geq v ( k - 1 ) \\ \frac{1}{2} M ( {v ( k )}^{2} - {v ( k - 1 )}^{2} ) {η}_{R} , & otherwise\end{matrix} & + \\ {f}_{cab} ( {T}_{amb} ( k ) , {u}_{A C} ( k ) ) + {f}_{bat} ( {T}_{amb} ( k ) ) & \end{matrix}$
  4: end for
  5: ΔSOC = f_{soc}(Eₜᵣᵢₚ)
  6: return Eₜᵣᵢₚ, ΔSOC
```

Algorithm 1 itself is straightforward to implement, provided that the various traffic, weather, and road input profiles, as well as the model parameters, are readily available. As can be seen, input features used in this example include the speed profile, elevation gain, link distance, ambient temperature, AC settings, road load, vehicle mass, powertrain, etc. However, the simplicity of Algorithm 1 often results in inconsistent prediction performance, primarily due to the low fidelity of the vehicle and AC energy models used in the algorithm. Conventional vehicle and AC energy models fail to take into account (1) real-world, actual road load forces that change depending on road and weather conditions, (2) changes in powertrain efficiencies that change depending on vehicle and weather conditions and (3) changes in AC power consumption reflecting varying AC settings and real-world weather conditions.

Accordingly, the illustrative methods described herein address these and at least the following four limitations by introducing an end-to-end trip energy prediction approach, where a comprehensive vehicle energy model is directly derived from real-world customer driving data while maintaining manageable implementation complexity and computational cost:
Variability in Parameters: Actual road load forces (A, B, C) and powertrain efficiencies (ηP, ηR) vary in the real world depending on vehicle, road, and weather conditions.
Modeling Challenges: Accurately modeling battery and cabin AC systems is challenging due to the variability in AC settings and real-world cabin and weather conditions.
Model Simplicity: The vehicle and AC energy models must be sufficiently simple to be implementable in a navigation system.
Computational Constraints: The computation cost and maximum turnaround time of the EV routing logic impose an upper limit on the number of links that can be evaluated per trip. For example, the disclosed methods herein use a smaller number of links (e.g., 10 links) than conventional methods (e.g., 1000 links) to predict the required energy to travel a 100 km trip. Note there is a maximum number of links that can be evaluated by conventional approaches.

Now, the extraction, transformation and loading (“ETL”) for modeling data preparation will now be described. High-quality modeling data is essential for any modeling activity. This section outlines the ETL process used to convert raw time-series EV driving data into manageable position-based data, which is then prepared for subsequent modeling tasks. Below is a general overview of the EV driving data used for these developments:
Date Period: 25 months
Total Driving Distance: >70 million miles
Total # of Unique States/Provinces: >50
Total Raw Data Size: ˜50 petabytes

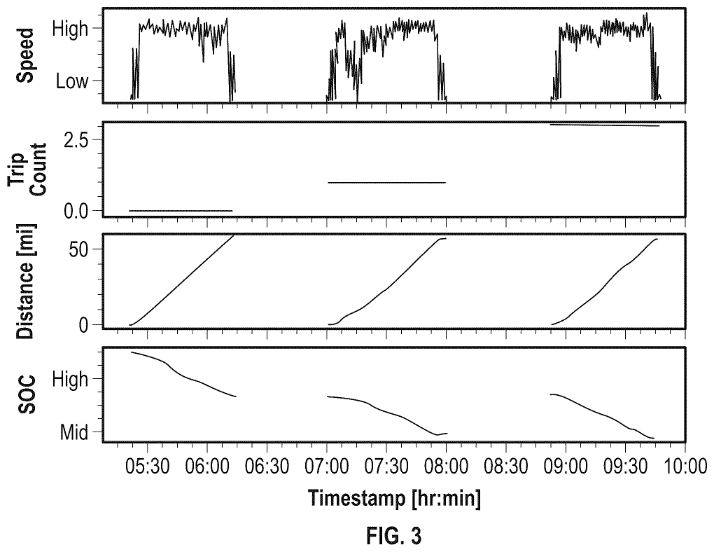

FIG. 3 is a chart of raw time-series data showing the speed, trip_{cnt}, distance and SOC over time, according to certain illustrative embodiments of the present disclosure. An ECU uses trip ent to mark a unique driving trip. In FIG. 3, the chart shows a sample set of time-series plots for speed, trip count (trip_{cnt}), distance and state of charge (SOC) of the traction battery pack from one of the drivers included in the dataset. The SOC signal is used as the primary battery energy indicator herein.

Although raw time-series data provide detailed insights into driving trips, they are too voluminous and complex for further modeling developments. Since the energy consumption dynamics of EVs change more slowly than the sampling rates of various powertrain signals-such as vehicle speed, accelerator pedal position, and battery power-a series of transformation steps is applied to reduce the time-series data of powertrain signals into manageable position based data, which is then prepared for modeling energy consumption dynamics.

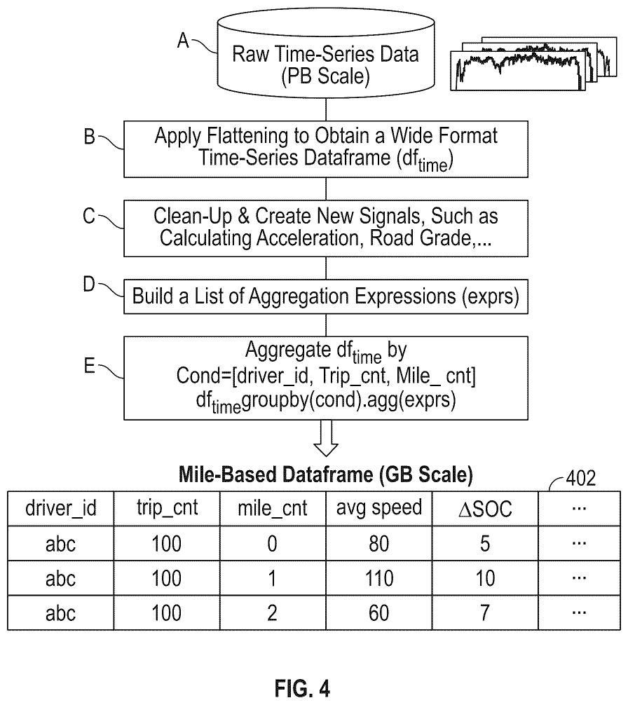

FIG. 4 illustrates the workflow for extraction and transformation of the raw time-series data of selected signals into position-based data, according to certain illustrative embodiments of the present disclosure. The position-based data includes various statistical attributes of the selected signals for each discrete driving distance, such as every m mile. Herein, this position-based data is referred to as the “mile-based dataframe” to emphasize that aggregation is performed for every specified m miles. In this example, Apache Spark (version 3.3.0) is used as the main distributed data processing platform to execute ETL scripts written in PySpark (LTS 11.3) on r5d.16×large clusters.

Still referring to FIG. 4, the raw time-series data initially come in a nested structure (block A), so data flattening is performed first to obtain the time-series dataframe, dfₜᵢₘₑ, at block B. The raw time-series data can include, for example, speed, SOC or ambient temperature profile data. This dataframe is organized in a wide and columnar format, where each row represents an array of signal values at a specific timestamp, and the columns store the values of each signal. The list of the schema for key columns in the time-series dataframe, including the identifier and counter columns is as follows: driver_{id}: A unique identifier for drivers; trip_{cnt}: A counter specifying unique trips; time: The timestamp of each data point entry; distance: The distance traveled; and speed: The speed of the vehicle.

At block C, the raw signals are cleaned-up and common functions are applied, such as, for example, calculating acceleration, bearing, road grade, etc. At block D, the system builds aggregation expressions to create a list of statistical features of the signals. Examples of statistical features include, but are not limited to, mean, median, maximum and minimum values. At block E, the system performs aggregation where the statistical features of selected signals are determined per their grouping conditions.

In this example, there are two main types of new signals that can be derived from existing signals to model sensor measurements that are not transmitted from the vehicle. The first type is time-order independent, where the time-order of existing signals does not need to be preserved when calculating the new signals, at block C. An example of this is a unit conversion from ° F. to ° C. The second type is time-order dependent, where the time-order of existing signals must be preserved when calculating new signals at block C, such as differentiating the speed and time signals to calculate acceleration. The first type of signal transformation is implemented using columnar operations, while the second type is implemented using window functions from Spark (pyspark.sql.Window) with appropriate partitioning and ordering conditions. Transforming the time-series dataframe into the mile-based dataframe is achieved by applying Spark's aggregation functions (pyspark.sql.DataFrame.agg) to the time-series dataframe at blocks D & E, as detailed in Algorithm 2 below. The following summarizes the statistical functions applied to the selected signals for each grouping condition, where the grouping is defined by the driver identifier, trip counter, and link counter: Mean, Median, Standard Deviation—The mean, median, and standard deviation of a signal within the group; Initial, Final—The values of a signal at the initial and final timestamps within the group; Minimum, Maximum—The minimum and maximum values of a signal within the group; and On %—the percentage of data points where a signal value is greater than 0 within the group. Note the algorithms described herein are expressed in pseudocode that combines elements of Python, Pandas, and PySpark.

Position/trip-based data is output at block E, thus providing trip-based data calculated for every X mile within each trip. GPS, time and weather data is also integrated here, resulting in mile-based data frame 402, for example. In addition to driver_id, trip_cnt, mile_cnt, avg speed and ΔSOC, the dataframe 402 can also include AC usage related features, such as ON % AC which represents the percentage of time when AC was on.

Algorithm 2 Aggregation of Time-Series
Data into Mile-Based Dataframes

| Input: Raw time-series data rawₜᵢₘₑ; List of signals of | |
|---|---|
| | interest xs: List of target statistical functions fs; List of |
| | target link distances ms. |
| Output: mile-based dataframes, dfₘᵢₗₑ | |
| | Initialisation : |
| 1: | Perform flattening on rawₜᵢₘₑ to obtain dfₜᵢₘₑ |
| 2: | Select xs from dfₜᵢₘₑ and create new signals in dfₜᵢₘₑ |
| 3: | for m in ms do |
| 4: | dfₜᵢₘₑ[“mile_{cnt}”] = int(dfₜᵢₘₑ[“distance”]/m) |
| 5: | exprs = [ ] |
| 6: | for x in xs do |
| 7: | for f in fs do |
| 8: | exprs.append(f(x)) |
| 9: | end for |
| 10: | end for |
| 11: | dfₘᵢₗₑ = ( |
| | dfₜᵢₘₑ |
| | .groupby(“driver_{id}”, “trip_{cnt}”, “mile_{cnt}”) |
| | .agg(exprs) |
| | .repartition(128, dayofweek(init_time)) |
| | ) |
| 12: | return dfₘᵢₗₑ |
| 13: | end for |

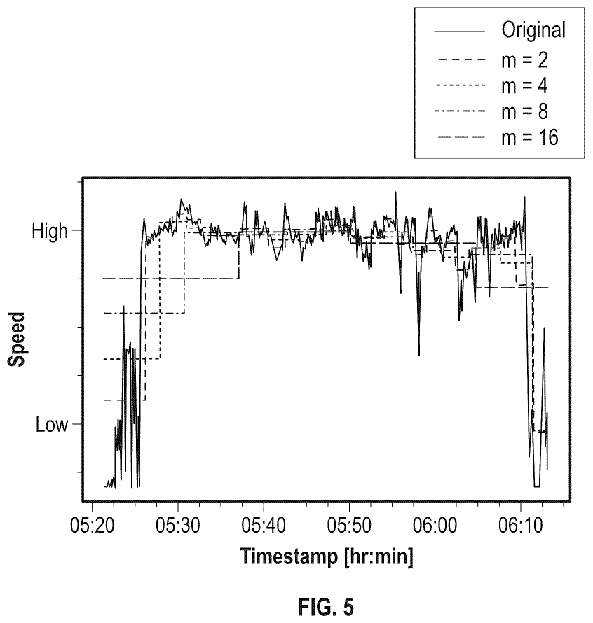

A key takeaway from the implementation of Algorithm 2 is that join operations between dataframes are intentionally avoided to enhance the efficiency and robustness of aggregating large datasets. The initial implementation included several join operations to determine the values of signals at the initial and final timestamps of the aggregation group. However, this approach led to inconsistent success rates during aggregation runs, often resulting in stage failures at shuffle map stages. This challenge with Spark was anticipated due to the extensive use of window functions to generate time-order dependent signals from large time series data, combined with the application of numerous aggregation functions across three grouping conditions. Rather than creating separate dataframes to store the values of signals at the initial and final timestamps and then joining them with the main aggregation dataframe in a subsequent step, the functions min_by and max_by from pyspark.sql.functions are utilized. These functions directly retrieve the values of signals at the initial and final timestamps by specifying time as the ordering column. Data skewness is mitigated by calling repartition after agg to evenly distribute the workload among workers by partitioning it by the driving day of the week, which should be normally distributed over two years of driving data. FIG. 5 is a chart illustrating the application of Algorithm 2, where the average function is applied to the speed signal for driving distances of 2, 4, 8, and 16 miles. Here, the chart illustrates the converting of the time-series data into mile based data.

Using Algorithm 2, the mile-based dataframe is generated by calculating specified statistical attributes of the selected signals for each driver, trip counter, and a list of target link distances [2, 4, 8, 16] miles. Rather than aggregating signals over a single link, this approach allows the same driving trip to be analyzed multiple times across the different link distances. Additional details on the use of the list of link distances are provided below. The final step in preparing the modeling data involves enhancing the milebased dataframe with weather information corresponding to the location at the initial timestamp. In certain illustrative embodiments, historical weather data is obtained through API calls to www.weatherapi.com by providing the location and time at the initial timestamp from the mile-based aggregation results. The Weather API returns various historical weather data points in JSON format, which are then merged with the mile-based dataframe to produce the final modeling dataframe. Below is a summary of the schema for the final modeling dataframe, df_{fin}:
driver_{id}: A unique identifier for drivers
trip_{cnt}: A counter specifying unique trips
mile_{cnt}: A counter indicating the index of the link within the trip
init_time: The time at the start of mile_{cnt}
fin_time: The time at the end of mile_{cnt}
avg_speed: The average value of speed within mile_{cnt}
med_speed: The median value of speed within mile_{cnt}
distance: The traveled distance within mile_{cnt}
temp_c: The ambient temperature at the initial location and time in mile_{cnt}
wind_kph, wind_degree: The wind speed and direction at the initial location and time in mile_{cnt}
pressure_mb: The ambient pressure at the initial location and time in mile_{cnt}
precip_mm: The precipitation amount at the initial location and time in mile_{cnt}
humidity: The humidity at the initial location and time in mile_{cnt}

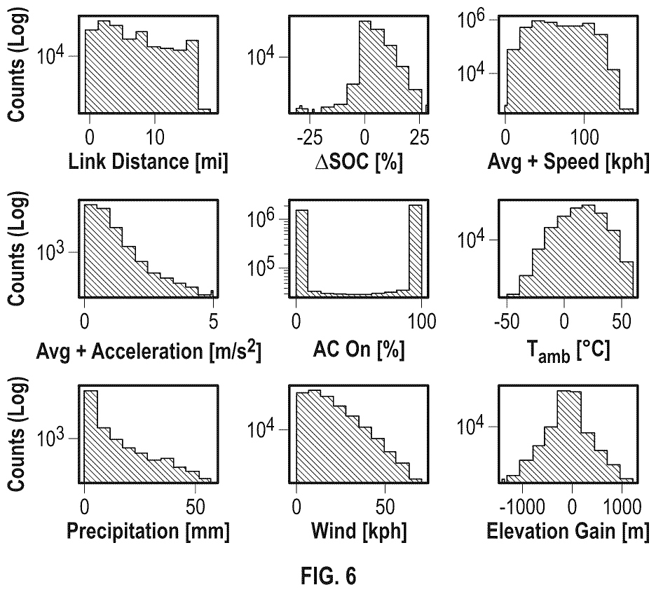

FIG. 6 presents histograms illustrating the distribution of key columns in the final modeling dataframe, df_{fin}. Histograms of the key columns in df_{fin} are presented on a log scale. The displayed columns include link distances, ΔSOC, average positive speed and acceleration, AC ON percentage, ambient temperature, precipitation amount, wind and elevation gain, shown from the top to the bottom rows. By aggregating the time-series data over various link distances, the final modeling dataframe encompasses aggregation results for link distances ranging from 2 to 16 miles. The driving data included in this study reflects a diverse range of driving and weather conditions, as depicted in FIG. 6.

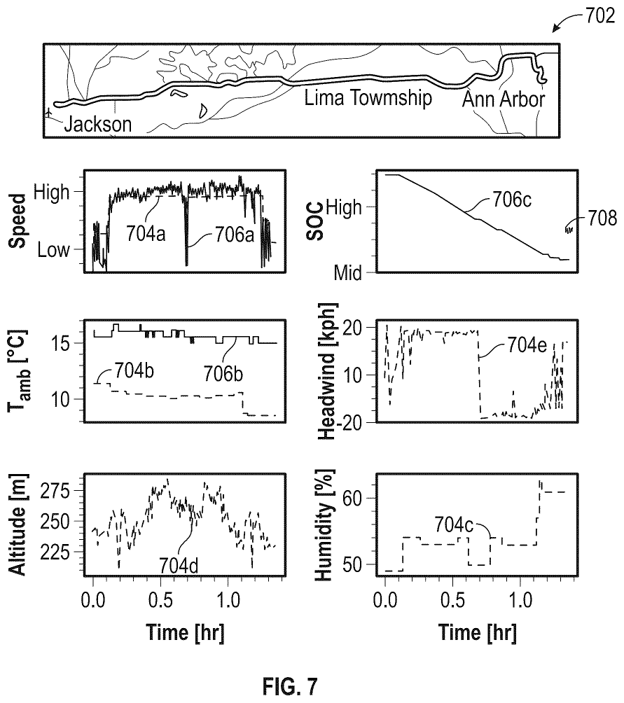

The concept of end-to-end (E2E) trip energy prediction, where a comprehensive vehicle energy model is directly derived from real-world driving data that captures various traffic, road, and weather conditions (e.g., across North America) will now be described. FIG. 7 illustrates one example of the trip energy prediction techniques provided herein where Algorithm 1 is used to calculate the total battery energy required to complete the trip driven by a company-owned vehicle. The GPS plot 702 illustrates a round trip from Ann Arbor, MI to Jackson, MI. The input feature profiles 704 derived from the map database, including speed limits 704a, ambient temperature 704b, humidity 704c, altitude 704d, and headwind 704e, are represented by 704a-e. Actual vehicle measurements 706, such as vehicle speed 706a, ambient temperature 706b, and SOC 706c, are depicted by lines 706a-c. The dot 708 on the SOC plot exemplifies the outcome of applying the 704a-4 input feature profiles to Algorithm 1 for calculating the final SOC at the trip's destination.

Still referring to FIG. 7, In certain illustrative embodiments, the energy models are trained using mile-based data aggregated over different link distances, which allows the model to handle input features with varying distances flexibly during the inference step. The E2E trip energy prediction described herein (embodied in the energy consumption and AC models) can be approached as a standard supervised machine learning (“ML”) development process. In this process, historical driving and weather input features from previous real-world trips, along with a label indicating the measured battery energy change ΔSOC for those trips, are used to train various ML models. On illustrative typical ML workflow is followed to prepare the modeling data, select and train model candidates, and finally evaluate them using test data and compare their performance against benchmarks. The E2E trip energy prediction utilizes a similar calculation scheme to that in Algorithm 1, but it employs ML models instead of the traditional vehicle and air conditioning models used in Algorithm 1. Regardless of the type of energy models used in the trip energy calculation, the goal remains to predict the total battery energy required to complete a given trip by considering traffic and road attributes along the trip, as illustrated in FIG. 7.

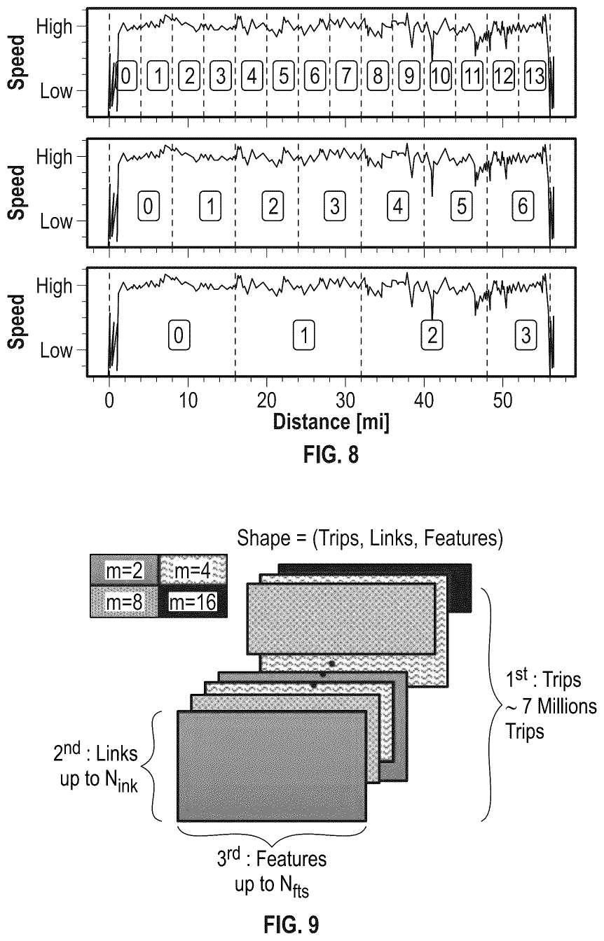

Data augmentation and preparation will now be discussed. In Algorithm 2, a list of link distances is used as one of the grouping conditions to aggregate the time-series data into mile-based data, resulting in aggregations over various link distances. FIG. 8 is a chart illustrating the process of aggregating the same driving trip using three different link distances: 4, 7 and 14, according to certain illustrative embodiments of the present disclosure. Data augmentation is used to create additional training data from the same driving trip.

With reference to FIG. 8, each driving trip is divided into multiple links per fixed distance to crate training data for the E2E energy models described herein. For each link of a fixed distance, statistics of the key signals used as input features for the E2E model are calculated. The speeds is shown over the link distances. As the link distance decreases, fewer data points are considered when calculating the statistical attributes of the selected signals, leading to more precise representations for the given position. The numerical values (0-13) displayed in the text boxes of the figure correspond to mile_{cnt} for the three link distances. The statistical attributes of the selected signals are computed using mile_{cnt} as one of the grouping conditions for aggregation. As shown, the 4-mile aggregated data provides a higher resolution of the statistical summary compared to the other aggregation results, as it is aggregated over a shorter link distance. Note that the final link of the trip may be shorter than the target link distance, as observed in the 16-mile aggregation results. This adjustment helps in obtaining mile-based data aggregated over different driven distances. The benefits and hypotheses of using the augmented mile-based data with varying link distances for developing the E2E trip energy prediction models described herein are summarized below:
Data Augmentation: In such embodiments, recycling the same driving trip data to create different aggregation results with various link distances expands the modeling hypothesis space. This approach enhances model robustness against statistical variations and aims to develop highly generalizable machine learning models.
Capturing Transient Conditions: Shorter link distances are essential for capturing transient changes in traffic, road, and weather conditions, which can vary significantly from one mile to the next.
Capturing Steady Conditions: Conversely, for driving events where conditions are consistent, such as long, flat freeway trips, longer link distances are beneficial for capturing steady driving conditions.
Handling Input Features with Varying Distances: A model trained with aggregation data from varying distances can effectively handle input features formulated from different link distances during an inference step, improving its adaptability to diverse driving conditions.

The final modelling dataframe is converted into a 3-dimensional tensor, as depicted in FIG. 9. In this example, this tensor is a NumPy array organized along three dimensions: trips (1st), links (2nd), and features (3rd). The gray scale and different textures represent the aggregated results for varying link distances. A separate list maintains the driver identifiers and trip counters, which is utilized when preparing the training, validation, and test datasets.

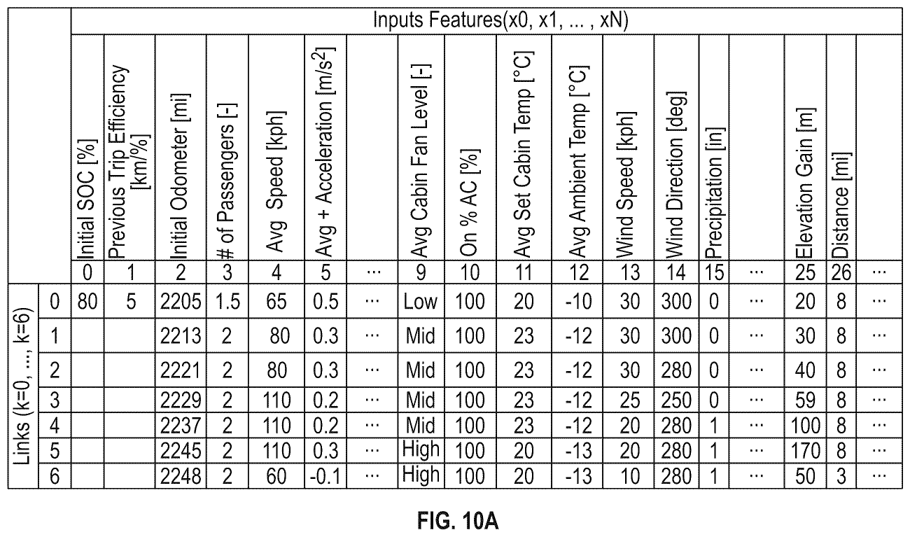

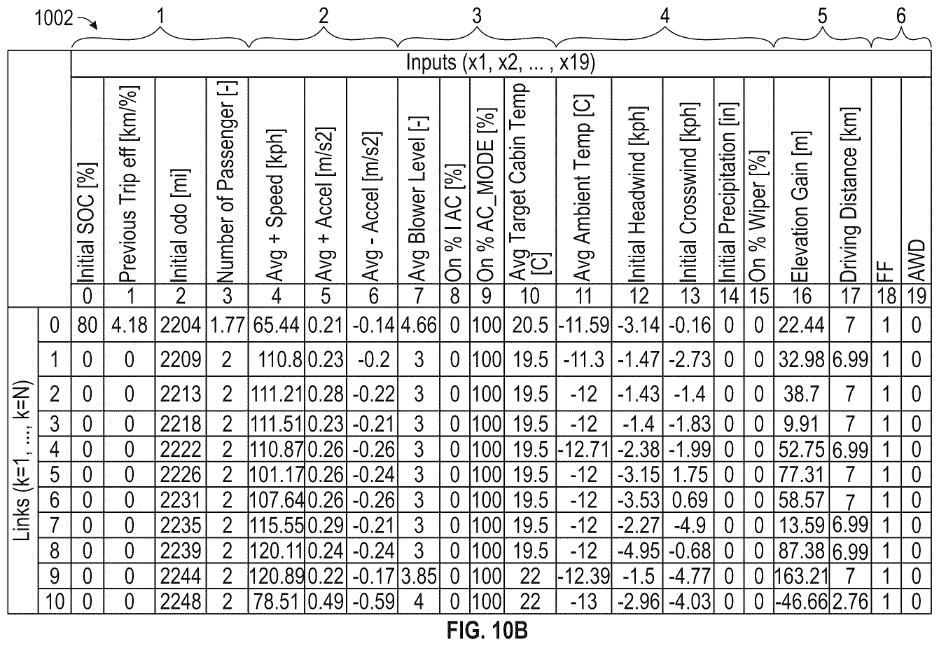

Now the model selection process will now be described. Here, one of the most crucial steps in model development is selecting the input features the E2E model should consider. Input features known to influence energy consumption are identified and summarized in FIG. 10A, according to certain illustrative embodiments of the present disclosure. This figure is a visualization of sampling one trip from the 3-dimensional array of FIG. 9 with the shape of (trips, links, features). In this visualization, the rows represent the links ordered from the initial to final locations, while the columns depict the statistical input features of the selected signals. Notably, only the first link includes the initial SOC and the historical efficiency from previous trips, providing the initial battery and vehicle conditions at the start of the trip. In FIG. 10, a sample input feature tensor from a trip with the 6 links is shown. The rows are the ordered links from the initial to final location.

FIG. 10B is a chart providing more detail of the selection of input features, according to certain illustrative embodiments of the present disclosure. Chart 1002 shows exemplary features known to influence vehicle energy consumption. Input features 1 are the current and previous vehicle conditions. Here, only the initial SOC of the first link of the trip is provided. Odometer readings are provided to capture the vehicle's age. Previous trip efficiency is used to capture previous driving conditions. The total number of passengers are estimated from seat belt and seat occupancy signals. Input features 2 are the average speed and acceleration along the trip. Input features 3 are HVAC settings along the trip. Here, various HVAC settings are provided to capture additional energy consumption from the HVAC system. Current batter and cabin temperatures were not included in this example. Input features 4 are weather conditions along the trip. Here, additional weather data from Map and Weather APIs were added to mode additional energy consumption due to changes in weather conditions. Input features 5 are road conditions along the trip. Here, road elevation gains are calculated from estimated road grade. Input features 6 are powertrain types (FF/AWD).

The goal of the model is to predict the trip energy, expressed as ΔSOC, based on a list of input features from the links ranging from k=0 . . . . Nₗᵢₙₖ. In this illustrative embodiment, to capture the temporal (time) relationships between current and previous links, a recurrent neural network (RNN) is selected instead of a feed-forward neural network (FNN).

$$Δ {SOC}_{FNN} = {\sum }_{k = 0}^{{N}_{link}} {f}_{FNN} ( {x}_{k} ; w ) \qquad ( 1 )$$

$$Δ {SOC}_{RNN} = {f}_{RNN} ( X ; w ) \qquad ( 2 )$$

During the inference step, the RNN calculates the trip ΔSOC directly from given features X and trained weights w shown in Equation (2) above. In contrast, the FNN iterates one k link at a time, summing the ΔSOC values of all individual links to compute the trip ΔSOC as described in Equation (1) above. Table I below provides details of the final RNN architecture for the E2E trip energy prediction models described herein. The illustrative model consists of sequential layers, beginning with an input feature layer of size (Nₗᵢₙₖ, N_{ft}), where Nₗᵢₙₖ, N_{ft} are the number of links and features, respectively. This is followed by a masking layer of the same size as the input feature layer. The next layer is a Long Short-Term Memory (LSTM) layer with a specified number of units Nᵤₙᵢₜ and using tanh as the activation function. The final layer is a single-unit-dense layer that converts the LSTM outputs into ΔSOC. The masking layer is crucial for handling missing features in the input feature tensors, which is important because some features may be unavailable due to cost or external API limitations.

TABLE I
OVERVIEW OF THE TRIP ENERGY MODEL BUILT WITH
MASKING AND LSTM LAYERS FROM TENSORFLOW

| Layers | Output Shape | # of parameters |
|---|---|---|
| Input | [(None, Nₗᵢₙₖ, N_{ft})] | 0 |
| Masking | (None, Nᵤₙᵢₜ, N_{fts}) | 0 |
| LSTM (tanh) | (None, Nᵤₙᵢₜ) | 4Nᵤ (Nᵤₙᵢₜ + N_{ft} + 1) |
| Output (dense) | (None, 1) | Nᵤₙᵢₜ + 1 |

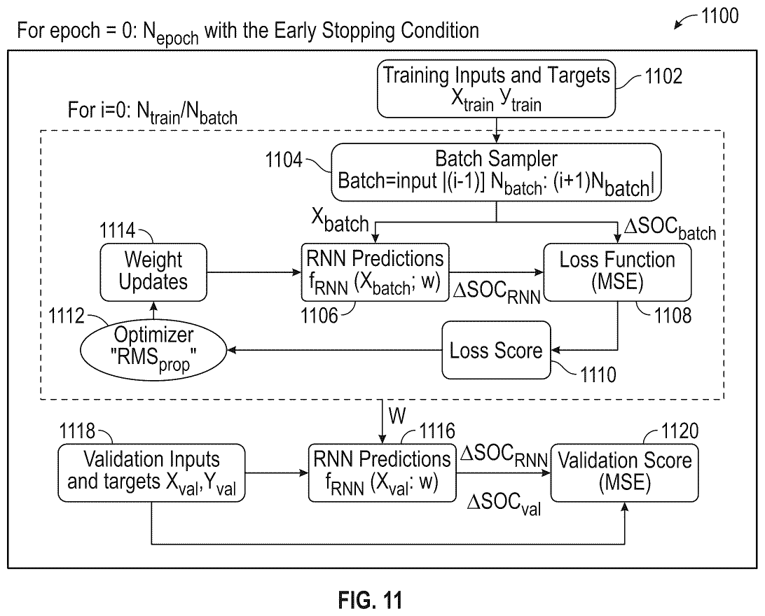

Model training and evaluation will now be discussed. During training, weights of the neural networks are optimized to minimize a loss function (MSE, Mean Squared Error) given the training input features and targets. Here, 80% of the total trips identified above with respect to the data augmentation and preparation were utilized for model training, comprising 5,610,523 trips, while the remaining trips were split equally for validation and testing, with 701,383 trips used for each. FIG. 11 is a process flow illustrating this exemplary model training and validation process. In this example, N_{epoch} is set to 100 with the early stopping condition to save a fitted model with the lowest validation score. N_{batch} is set to 128. RMSprop is used as the optimizer with its default parameters from Keras-Tensorflow.

As shown in FIG. 11, the training process 1100 begins by preparing the training dataset at block 1102 where the training input feature tensors and targets are prepared from real-world customer driving data (Xₜᵣₐᵢₙ refers to the training input feature tensors, yₜᵣₐᵢₙ refers to the training targets as in ΔSOC). At block 1104, a batch of the training input feature tensors is sampled and is provided as the input to the ML model at block 1106 to make RNN Predictions which is the ΔSOC_{RNN} (the predicted value). The target values (the ΔSOC to be predicted) are also output at block 1104 in order to determine the MSE between the ΔSOC_{RNN} and target values (ΔSOC_{batch}), at block 1108. At block 1110, the loss score is output to the optimizer at block 1112 in order to optimally update the weight (w) given the score. The model's weights are updated at block 114 by minimizing the mean squared error loss between the predicted and true SOC values, continuing until the model's performance no longer improves when evaluated on the validation dataset. The Early Stopping Condition refers to the instance when, during iterations, no improvement to the validation score is seen (in such an instance, the iterations can be stopped before the maximum number of iterations is performed). After all training datasets are exhausted, the corresponding optimal weights (W) are output at block 1116 to evaluate the ML model once more using a validation dataset 1118 and corresponding validation score 1120, which is the MSE.

Still referring to FIG. 11, the objective is to optimize 23,552 neural network weights (w) to minimize the mean squared error (MSE) loss function between the true ΔSOC and the predicted ΔSOC, as defined in Equation (3) below.

$$arg {min}_{w} {\sum }_{epoch = 0}^{{N}_{epoch}} {\sum }_{i = 0}^{{N}_{train}} MSE ( Δ {SOC}_{true , i} , Δ {SOC}_{RNN} ) \qquad ( 3 )$$

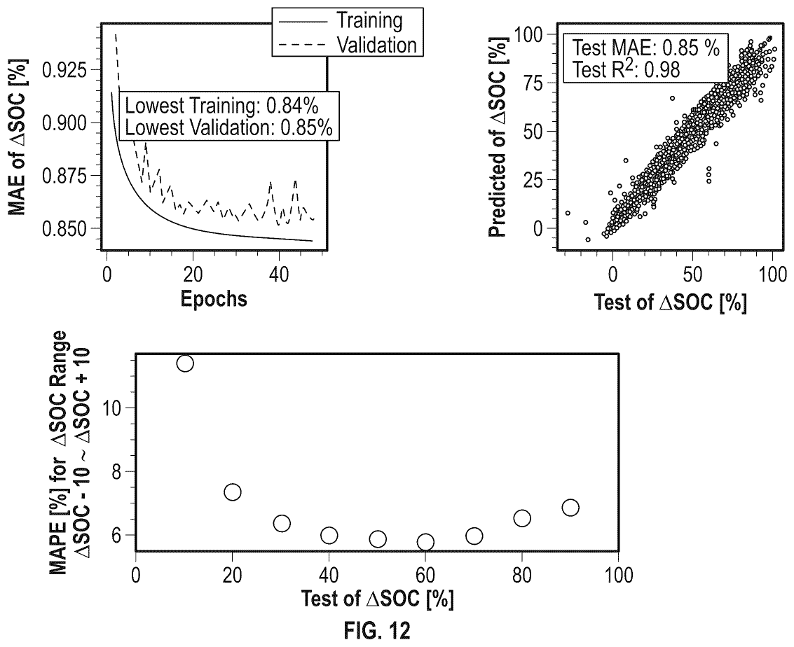

As mentioned above, the training is conducted over N_{epochs}=100 epochs, with a batch size of N_{batch}=128. Early stopping condition is implemented to halt training if the validation loss does not improve within, for example, a patience window of 10 epochs. The results of the model training, validation, and testing are summarized in FIG. 12. Summary of the model training, validation and test results are shown on the top. The mean absolute percent error (MAPE) of test data for different ΔSOC ranges are shown on the bottom highlighting that the model performs better for trips with ΔSOC greater than 40%. Mean Absolute Error (MAE) is used as the primary metric for evaluating training and validation performance, as shown in the top-left figure. The lowest validation MAE is slightly higher than the training MAE, with both values around 0.85%, indicating minimal overfitting or underfitting.

The result of evaluating the illustrative trained model using the test data that the model had not encountered during training and validation steps is shown on the top-right of FIG. 12. The trained model achieves the similar MAE between validation and test data (0.84% vs. 0.85%) as well as with the high R² of 0.98 highlighting characteristics of accurate and generalizable ML models. R² is the coefficient of determination which ranges from 0 to 1. R² closer to 1 means the model is highly accurate. FIG. 12 reveals the MAPE of the model for the test trips with varying ΔSOC ranges, as shown in the lower graph. The results suggest the model performs better for trips with larger ΔSOC changes, which are typically associated with longer trips. This is advantageous for trip energy prediction, as EV routing logic is generally applied to longer trips, where EV chargers are less frequently available compared to shorter trips.

TABLE II
SUMMARY OF ONE LAYER RNN ENERGY
MODEL WITH THE DIFFERENT # OF
UNITS AND AUGMENTATION ms

| # of | | MAE | Test MAE with different ms | | | | |
|---|---|---|---|---|---|---|---|
| Units | ms | (train, val.) | all | 2 | 4 | 8 | 16 |
| 32 | 2, 4, 8, 16 | (0.87, 0.87) | 0.87 | 0.83 | 0.86 | 0.88 | 0.91 |
| 64 | 2, 4, 8, 16 | (0.84, 0.85) | 0.85 | 0.81 | 0.84 | 0.86 | 0.90 |
| 128 | 2, 4, 8, 16 | (0.81, 0.84) | 0.85 | 0.79 | 0.83 | 0.85 | 0.90 |
| 64 | 2 | (0.79, 0.80) | 4.5 | 0.8 | 3.3 | 5.5 | 7.9 |
| 64 | 4 | (0.82, 0.83) | 4.0 | 7.4 | 0.83 | 2.7 | 5.6 |
| 64 | 8 | (0.84, 0.86) | 5.5 | 13.9 | 6.3 | 0.86 | 2.27 |
| 64 | 16 | (0.87, 0.89) | 4.16 | 7.41 | 5.63 | 3.19 | 0.90 |

Table II summarizes the performance of the model configured with varying numbers of RNN (e.g., LSTM) units and trained with different levels of data augmentation. The first three rows of the table highlight the effects of using a greater number of RNN/LSTM units with fully augmented data, where time-series data are aggregated over four link distances: ms=[2, 4, 8, 16]. The model with the highest number of units (128) exhibits signs of overfitting, as evidenced by a notable difference between training and validation (and test) MAEs. The last four rows of the table present results from models trained without data augmentation, using only a single link distance for aggregation. Although these models show slightly lower training and validation MAEs compared to those trained with fully augmented data, they do not generalize well when tested with input features derived from link distances different from the link distance used during training. For instance, the model trained on data aggregated with ms=[4] achieves comparable train, validation, and test MAEs (0.82, 0.83, 0.83) only when evaluated on test data aggregated with ms=[4]. The performance deteriorates significantly for test data aggregated with ms=[2, 8, 16], with respective MAEs of 7.4, 2.7, and 5.6. In contrast, models trained with fully augmented data exhibit consistent test MAEs across different link distances, validating the effectiveness of data augmentation in achieving highly generalizable models.

Model evaluations with benchmarks will now be discussed. The E2E trip energy prediction methods described here were compared against two benchmark methods commonly used in the industry. The first benchmark represents a basic approach to trip energy calculation, where historical efficiencies from the vehicle's ECU, along with the total driving distance of an upcoming trip, are used to estimate the trip energy, as outlined in Algorithm 3. The second benchmark involves a conventional EV routing logic, where the vehicle and AC energy models evaluate traffic, road, and weather input feature profiles to estimate trip energy, as described in Algorithm 1. In this comparison, the AC energy consumption models are replaced with the average value of measured AC energy during an idle period to simplify the calculations. The vehicle model parameters (A, B, C, M) are used to perform vehicle testing and derive fuel economy labels.

Algorithm 3 Calculation of Required Battery Energy Using
Historical Efficiencies and Trip Distance

```
Input: Total trip distance dₜᵣᵢₚ, Historical vehicle and AC
  efficiencies from ECU η_{veh,hist}, η_{AC,hist}
Output: ΔSOCₕᵢₛₜ
  $1 : Δ {SOC}_{hist} = {d}_{trip} {η}_{veh , hist}^{- 1} {η}_{A C , hist}^{- 1}$
  2: return ΔSOCₕᵢₛₜ
```

Finally, Algorithm 4 describes the calculation process of the E2E trip energy prediction method where it uses similar input feature profiles as Algorithm 1 but includes an additional step to format these input feature profiles into a tensor structure compatible with the model.

Algorithm 4 Calculation of Required Battery
Energy Using E2E Trip Energy Prediction

| Input: Speed profile of the trip v(k); Elevation gain profile | |
|---|---|
| | Δz(k); Link distance profile d(k); Ambient temperature |
| | profile T_{amb}(k); AC user setting profiles u_{AC}(k); Vari- |
| | ous weather profiles W(k); Target distance window m; |
| | Trained weight w of f_{RN N}(X; w); Arrays of the input |
| | feature's average and standard deviation values μᵢₙ, σᵢₙ |
| Output: ΔSOC_{RN N} | |
| 1: | df_{X} = DataFrame(d, v, z, T_{amb}, ..., u_{AC}, W) |
| 2: | df_{X}[“mile_{cnt}”] = int(df_{X}[“d”]/m) |
| 3: | Build aggregation expressions exprs to generate the re- |
| | quired input features |
| 4: | X = df_{X}.groupby(“mile_{cnt}” ).agg(exprs) |
| 5: | X = (X − μᵢₙ)/σᵢₙ |
| 6: | Replace entries of X with a masked value for the unavail- |
| | able features |
| 7: | ΔSOC_{RNN} = f_{RNN}(X; w) |
| 8: | return ΔSOC_{RN N} |

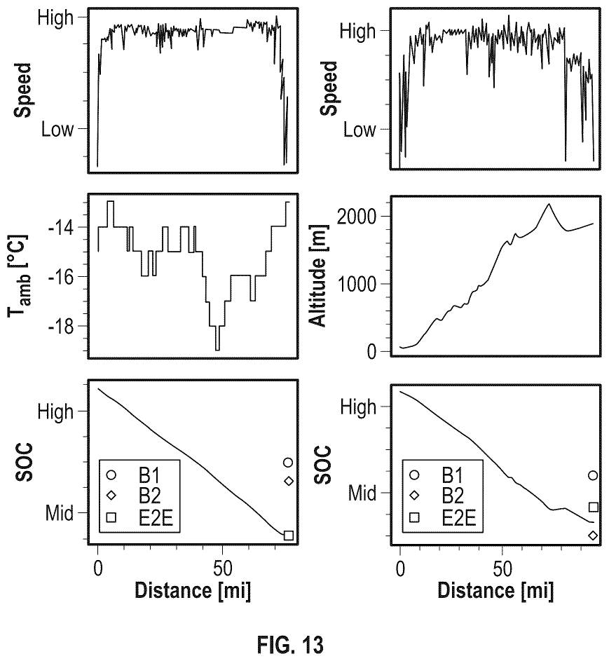

FIG. 13 shows charts illustrating the evaluation of three exemplary methods under extreme weather and driving conditions in North America. The left-side charts illustrate a cold winter driving trip in the Northeast region, while the right figure depicts a long, climbing trip from the West region. The final SOC predictions are presented in the bottom-right SOC plot. In this plot, Benchmark 1 (B1), which represents the historical efficiency-based prediction, is indicated by a circle; Benchmark 2 (B2), which uses typical EV routing methods, is shown as a diamond; and the results from the E2E model are represented by a square.

In further description, the left-side charts reflect a 75-mile driving trip from the Northeast region during winter with the average ambient temperature of −15° C. The right-side charts reflect a 95-mile driving trip from the West region with more than a 2000 meter of the elevation gain. The same input profiles are used to compare Algorithm 1 and Algorithm 4 fairly. Actual measurements of vehicle speed and elevation gain are used as input profiles, rather than inputting traffic speed, speed limits, and elevation data from map databases. This approach ensures that the evaluation focuses solely on the performance of the energy models in the two algorithms.

A discussion of the results will now be provided. The percentage error equation shown in Equation (4) is used to calculate the percentage error between the true and predicted ΔSOC to compare the trip energy prediction results of the two benchmarks and the E2E trip energy prediction method.

$$\% error = \frac{Δ {SOC}_{pred} - Δ {SOC}_{true}}{Δ {SOC}_{true}} \qquad ( 4 )$$

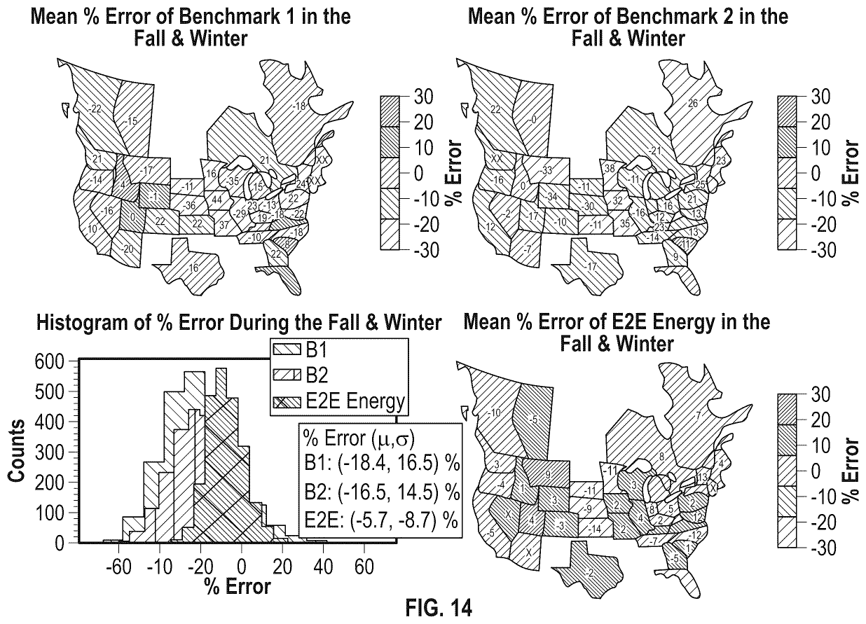

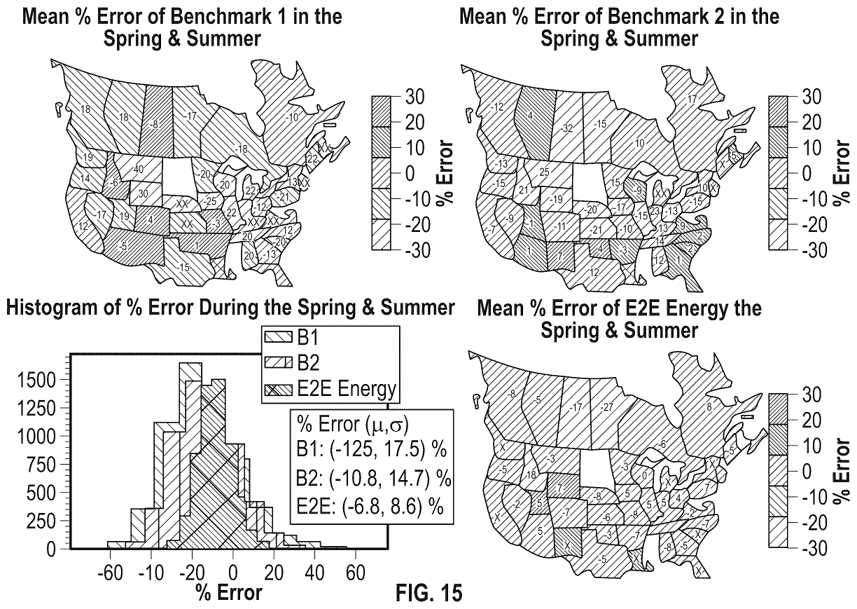

The three illustrative trip energy prediction methods were evaluated using a subset of long-distance and high-speed driving trips (greater than 30 miles and average speeds above 80 mph). The selected trips are aggregated over a 5-mile link distance, which differs from the link distances used during model development (2, 4, 8, and 16 miles). This approach was intentionally chosen to assess the performance of the E2E energy model with input feature tensors constructed using a link distance not included in the augmented datasets. The prediction results are aggregated by location (states and provinces) and season (spring and summer versus fall and winter) to highlight the impact of locality and seasonality on the different methods, as summarized in FIGS. 14 and 15. The histograms of percentage error for the three methods are presented in the figures to demonstrate that the E2E methods described herein achieve superior prediction accuracy (lower mean u) and consistency (lower standard deviation σ) compared to the two benchmark methods. The evaluation results for fall and winter, shown in FIG. 14, underscore the strengths of the E2E model. The model performs consistently well, achieving approximately one-third of the percentage error compared to the two benchmarks. This is particularly promising for EV energy consumption, which is known to fluctuate significantly under cold ambient conditions.

In FIG. 14, the aggregated percentage error results for Benchmark 1, Benchmark 2, and the E2E trip energy prediction methods during fall and winter are presented in clockwise order. The input tensors for the E2E model were prepared using a 5-mile link distance. The histogram of percentage error results for all three methods is shown in the bottom-left corner.

In FIG. 15, the aggregated percentage error results for Benchmark 1, Benchmark 2, and the E2E trip energy prediction methods during spring and summer are presented in clockwise order. The input tensors for the E2E model are prepared using a 5-mile link distance. The histogram of percentage error results for all three methods is shown in the bottom-left corner.

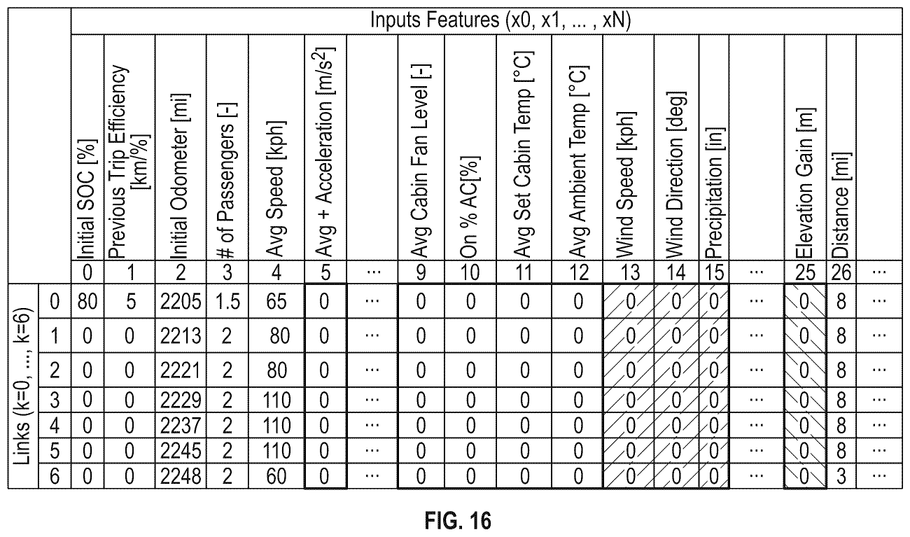

In certain illustrative embodiments certain input features can be disabled, a discussion of which will now be provided. One of the advantages of implementing the E2E trip energy prediction model as an RNN with a masking layer is its ability to handle missing entries in the input feature tensors. Table III below summarizes the results of four cases where specific input features were systematically disabled to assess their impact on the model's performance. Disabling a feature involves replacing the entries in the 3D NumPy array with a designated mask value, as illustrated in the chart of FIG. 16 which shows an example of the input feature tensor when some of the input features are not available. For the purpose of evaluating the impact of missing features on model performance, the input tensor has been manually modified to simulate the absence of specific features. The missing features for the four scenarios are shown in columns 5, 9-15 and 25.

Only test trips with a ΔSOC greater than 10% were included in this study. In the first case, where the elevation gain feature is omitted from the input tensors, the MAE increased by approximately 20% ((1.63−1.36)/1.36), and the predictions became more inconsistent, as indicated by higher standard deviations of the percentage error. This outcome was expected, as omitting elevation gain means the model cannot account for the additional battery energy required to overcome gravitational forces during hill climbs.

TABLE III
SUMMARY OF DISABLING SOME OF THE INPUT FEATURES
TO THE E2E ENERGY PREDICTIONS WHEN USING THE
TEST DATA WITH MORE THAN ΔSOC OF 10%

| | | ΔSOC | % error |
|---|---|---|---|
| Case | Disabled features | MAE | (μ, σ) |
| 0 | None | 1.36 | (−0.5, 9.3) |
| 1 | Elevation gain related | 1.63 | (−0.76, 11.75) |
| 2 | Acceleration related | 1.69 | (1.15, 11.37) |
| 3 | Temperature and AC | 2.42 | (−5.8, 15.6) |
| | setting related | | |
| 4 | Temperature, AC setting, | 2.54 | (−5.6, 16.0) |
| | and weather related | | |

The second case, where acceleration-related features are omitted, shows a similar impact to that of omitting the elevation gain feature. Increases in the metrics were anticipated because the model fails to capture the additional battery energy spent or recovered during acceleration and braking. The third and fourth cases have the most significant impact on the metrics. In these cases, omitting temperature, AC settings, and weather-related features (Case 4) causes the model to underpredict (ΔSOC_{pred}<ΔSOCₜᵣᵤₑ), resulting in a highly negative mean of the percentage error. The sharp increases in MAE and σ values confirm the importance of including features that can represent changes in energy consumption due to varying ambient temperatures and AC settings. Omitting weather-related features results in slightly less consistent predictions compared to Case 3, likely because extreme windy and precipitation conditions are not captured.

There can also be differing impacts when using the different link distances during inference. In certain illustrative embodiments, the same driving trip can be aggregated with different link distances, resulting in input feature tensors of varying heights (i.e., number of rows). Using a shorter input tensor, which is generated from a longer link distance, offers advantages in computational efficiency, as an RNN requires fewer evaluations to make inferences. However, shorter input tensors may lack sufficient detail about the driving trip, potentially leading to a decline in model performance compared to evaluations using taller input tensors. Table II summarizes the trade-off between link distances and model performance. It confirms that the model performs better when evaluated with input feature tensors derived from shorter link distances. For instance, the MAEs of the model with 64 units, trained on the fully augmented data, increase monotonically from 0.80 to 0.90 when evaluated with input tensors generated from link distances ranging from 2 to 16 miles.

Accordingly, the illustrative embodiments described herein present an end-to-end ML development process, beginning with a detailed description of how raw time-series data was converted into mile-based data. This conversion involved signal transformation to create new signals from existing ones and the use of an external API to incorporate weather-related information. The mile-based data were further enhanced by aggregating time-series data over various link distances. This data augmentation step led to the development of a generalizable trip energy prediction model, implemented as an RNN, capable of handling input feature tensors constructed from varying link distances. A masking layer in the RNN enabled the model to handle missing entries in the input feature tensors, which is especially important when all features are not available in a production environment. The RNN, with 64 units and trained on the fully augmented data, was selected to evaluate its performance against two benchmark EV solutions.

The three illustrative prediction methods were evaluated using a subset of long distance and high-speed trips across the four seasons and various locations in North America. The E2E model excelled at providing accurate and consistent ΔSOC predictions even during the winter season while maintaining low computational costs by using input feature tensors constructed from a 5-mile link distance. This performance was evidenced by achieving a consistently lower percentage error between ΔSOC_{pred} and ΔSOCₜᵣᵤₑ compared to the two benchmark methods. The masking layer in the RNN was used to systematically assess the impact of missing input features on trip energy predictions. Omitting elevation gain and acceleration-related features lowered prediction accuracy because it prevented the model from capturing additional energy spent or recovered from overcoming inertia and gravitational forces. However, omitting temperature and AC settings had the most significant impact, underscoring the critical need to include these factors for accurate and consistent trip energy predictions.

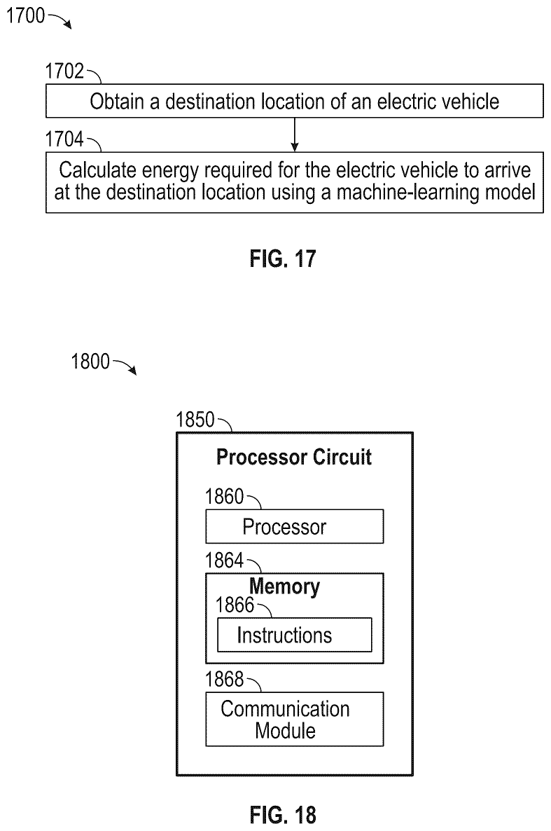

In view of the foregoing, FIG. 17 is a flow chart of a method to predict trip energy required for electric vehicles, according to certain illustrative embodiments of the present disclosure. In this example, at block 1702 of method 1700, a destination location of an electric vehicle is obtained via a user interface. At block 1704, the energy required for the electric vehicle to arrive at the destination is calculated using a machine-learning model. The machine-learning model comprises an energy consumption model that predicts variability of the vehicle energy consumption, based upon input features, while being driven to the destination location. Here, after obtaining the destination information, the system determines the trip route and the corresponding input features (e.g., speed profile, road grade, etc.) resulting from the trip route. The machine-learning model also includes an air-conditioning model that predicts variability of an AC system of the electric vehicle while being driven to the destination location. The variability in energy consumption and AC use is used by the ML model to determine the total energy required for the vehicle to traverse the trip, as described herein.

It is noted that flow diagrams are provided herein for exemplary purposes; a person of ordinary skill in the art will recognize myriad variations that nonetheless fall within the scope of the present disclosure. For example, the logic of flow diagrams may be shown as sequential. However, similar logic could be parallel, massively parallel, object oriented, real-time, event-driven, cellular automaton, or otherwise, while accomplishing the same or similar functions. In order to perform the methods described herein, a processor may divide each of the steps described herein into a plurality of machine instructions, and may execute these instructions at the rate of several hundred, several thousand, several million, or several billion per second, in a single processor or across a plurality of processors. Such rapid execution may be necessary in order to execute the method in real time or near-real time as described herein. For example, in order to determine preferred information communication variants in real time, the system 100 may need to execute multiple times per second (e.g., a rate of 10 Hz, 20 Hz, etc.).

Accordingly, the described systems and methods provide a number of advantages. First, based on the discussion provided herein, the E2E trip energy prediction methods clearly outperform conventional EV routing methods even with a much smaller number of links evaluated per trip. Additional performance improvements are possible using shorter links per trip (e.g., 5 km)—which indicates its critical to have a general and yet accurate information about road, weather and HVAC conditions of the trip. Second, the illustrated E2E methods generalizes well for different ambient and weather conditions. The system's performance further does not vary much between summer and winter seasons, as reflected in the chart below:

| Summary of evaluating the three | Spring, Summer | Fall, Winter |
|---|---|---|
| methods using long-distance | (μ, σ) of | (μ, σ) of |
| high-speed trips | % error ΔSOC | % error ΔSOC |
| Historical efficiency based | (−12.5, 17.7) | (−18.5, 16.5) |
| Standard EV routing method | (23.6, 13.6) | (15.5, 15.6) |
| E2E trip energy predictions | (0.0, 8.7) | (0.3, 8.4) |

FIG. 18 is a schematic diagram of a processor circuit 1850, in accordance with at least one embodiment of the present disclosure. The processor circuit 1850 may be implemented in the system 100, or other devices or workstations (e.g., third-party workstations, network routers, etc.), or on a cloud processor or other remote processing unit, as necessary to implement the methods described herein. As shown, the processor circuit 1850 may include a processor 1860, a memory 1864 having instructions 1866 thereon, and a communication module 1868. These elements may be in direct or indirect communication with each other, for example via one or more buses.

The processor 1860 may include a central processing unit (CPU), a digital signal processor (DSP), an ASIC, a controller, or any combination of general-purpose computing devices, reduced instruction set computing (RISC) devices, application-specific integrated circuits (ASICs), field programmable gate arrays (FPGAs), or other related logic devices, including mechanical and quantum computers. The processor 1860 may also comprise another hardware device, a firmware device, or any combination thereof configured to perform the operations described herein. The processor 1860 may also be implemented as a combination of computing devices, e.g., a combination of a DSP and a microprocessor, a plurality of microprocessors, one or more microprocessors in conjunction with a DSP core, or any other such configuration.

The memory 1864 may include a cache memory (e.g., a cache memory of the processor 660), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an embodiment, the memory 1864 includes a non-transitory computer-readable medium. The memory 1864 may store instructions 1866. The instructions 1866 may include instructions that, when executed by the processor 1860, cause the processor 1860 to perform the operations described herein. Instructions 1866 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The communication module 1868 can include any electronic circuitry and/or logic circuitry to facilitate direct or indirect communication of data between the processor circuit 1850, and other processors or devices. In that regard, the communication module 1868 can be an input/output (I/O) device. In some instances, the communication module 1868 facilitates direct or indirect communication between various elements of the processor circuit 1850 and/or the system 100. The communication module 1868 may communicate within the processor circuit 1850 through numerous methods or protocols. Serial communication protocols may include but are not limited to United States Serial Protocol Interface (US SPI), Inter-Integrated Circuit (I²C), Recommended Standard 232 (RS-232), RS-485, Controller Area Network (CAN), Ethernet, Aeronautical Radio, Incorporated 429 (ARINC 429), MODBUS, Military Standard 1553 (MIL-STD-1553), or any other suitable method or protocol. Parallel protocols include but are not limited to Industry Standard Architecture (ISA), Advanced Technology Attachment (ATA), Small Computer System Interface (SCSI), Peripheral Component Interconnect (PCI), Institute of Electrical and Electronics Engineers 488 (IEEE-488), IEEE-1284, and other suitable protocols. Where appropriate, serial and parallel communications may be bridged by a Universal Asynchronous Receiver Transmitter (UART), Universal Synchronous Receiver Transmitter (USART), or other appropriate subsystem.

External communication (including but not limited to software updates, firmware updates, preset sharing between the processor and central server, or readings from vehicle or environmental sensors) may be accomplished using any suitable wireless or wired communication technology, such as a cable interface such as a universal serial bus (USB), micro USB, Lightning, or FireWire interface, Bluetooth, Wi-Fi, ZigBee, Li-Fi, or cellular data connections such as 2G/GSM (global system for mobiles), 3G/UMTS (universal mobile telecommunications system), 4G, long term evolution (LTE), WiMax, or 5G. For example, a Bluetooth Low Energy (BLE) radio can be used to establish connectivity with a cloud service, for transmission of data, and for receipt of software patches. The controller may be configured to communicate with a remote server, or a local device such as a laptop, tablet, or handheld device, or may include a display capable of showing status variables and other information. Information may also be transferred on physical media such as a USB flash drive or memory stick.

The technology described herein may be implemented on manually controlled vehicles or driver-assist vehicles. The technology may be implemented in diverse combinations of hardware, software, and firmware, depending on the implementation or as necessitated by the structures and modules already present in existing vehicles. The system may be employed on vehicles with automatic transmission, manual transmissions, or vehicles with simulated shifting, including continuously variable transmission (CVT), infinitely variable transmission (IVT), hybrid transmissions (e.g., a hybrid vehicle with 4-speed automatic transmission simulating 10 gears), and fully electric vehicles.

These and other advantages will be readily apparent to those ordinarily skilled in the art having the benefit of this disclosure.

Methods and embodiments described herein further relate to any one or more of the following paragraphs:

1. A computer-implemented method to predict trip energy required for electric vehicles, the method comprising: obtaining, via a user interface, a destination location of an electric vehicle; and calculating, using a machine learning (“ML”) model, energy required for the electric vehicle to arrive at the destination location, wherein the ML model comprises: an energy consumption model that predicts, based upon vehicle input features, variability of vehicle energy consumption while being driven to the destination location; and an air-conditioning (“AC”) model that predicts variability of an AC system of the electric vehicle while being driven to the destination location.

2. The computer-implemented method as defined in paragraph 1, wherein the ML model utilizes a recurrent neural network (“RNN”) to predict the energy required to arrive at the destination location.

3. The computer-implemented method as defined in paragraphs 1 or 2, wherein the RNN is trained using mile-based data aggregated over different link distances, the link distances being road segments.

4. The computer-implemented method as defined in any of paragraphs 1-3, wherein the link distances are road segments with at least one of a constant traffic attribute and constant road attribute.

5. The computer-implemented method as defined in any of paragraphs 1-4, wherein the ML model utilizes the RNN to determine a temporal relationship between the road segments.

6. The computer-implemented method as defined in any of paragraphs 1-5, wherein the ML model is derived from real-world driving data of electric vehicle users obtained during previous trips.

7. The computer-implemented method as defined in any of paragraphs 1-6, wherein the real-world driving data captures various traffic, road and weather conditions.

8. The computer-implemented method as defined in any of paragraphs 1-7, wherein the vehicle input features account for at least one of a speed limit, traffic speed, road elevation, road conditions and wind conditions along a route to the destination location.

9. The computer-implemented method as defined in any of paragraphs 1-8, wherein the AC model accounts for variation in ambient temperature along a route to the destination location.

10. A system to predict trip energy required for electric vehicles, the system comprising: a processor having a memory and configured to perform operations comprising: obtaining, via a user interface, a destination location of an electric vehicle; and calculating, using a machine learning (“ML”) model, energy required for the electric vehicle to arrive at the destination location, wherein the ML model comprises an energy consumption model that predicts, based upon vehicle input features, variability of vehicle energy consumption while being driven to the destination location; and an air-conditioning (“AC”) model that predicts variability of an AC system of the electric vehicle while being driven to the destination location.

11. The system as defined in paragraph 10, wherein the ML model utilizes a recurrent neural network (“RNN”) to predict the energy required to arrive at the destination location.

12. The system as defined in paragraph 10 or 11, wherein the RNN is trained using mile-based data aggregated over different link distances, the link distances being road segments.

13. The system as defined in any of paragraphs 10-12, wherein the ML model is derived from real-world driving data of electric vehicle users obtained during previous trips.

14. The system as defined in any of paragraphs 10-13, wherein the vehicle input features account for at least one of a speed limit, traffic speed, road elevation, road conditions and wind conditions along a route to the destination location.

15. The system as defined in any of paragraphs 10-14, wherein the AC model accounts for variation in ambient temperature along a route to the destination location.

Moreover, the methods described herein may be embodied within a system comprising processing circuitry to implement any of the methods, or a in a non-transitory computer-readable medium comprising instructions which, when executed by at least one processor, causes the processor to perform any of the methods described herein. Accordingly, the logical operations making up the embodiments of the technology described herein may be referred to variously as operations, steps, blocks, objects, elements, components, or modules. Furthermore, it should be understood that these may occur or be arranged in any order, unless explicitly claimed otherwise or a specific order is necessitated by the claim language or by the nature of the component or step.

All directional references e.g., upper, lower, inner, outer, upward, downward, left, right, lateral, front, back, top, bottom, above, below, vertical, horizontal, clockwise, counterclockwise, proximal, and distal are only used for identification purposes to aid the reader's understanding of the claimed subject matter, and do not create limitations. Connection references, e.g., attached, coupled, connected, and joined are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/or” rather than “exclusive or.” Unless otherwise noted in the claims, stated values shall be interpreted as illustrative only and shall not be taken to be limiting.

The above specification, examples and data provide a complete description of the structure and use of exemplary embodiments of the vehicle door activating system as defined in the claims. Although various embodiments of the claimed subject matter have been described above with a certain degree of particularity, or with reference to one or more individual embodiments, those skilled in the art could make numerous alterations to the disclosed embodiments without departing from the spirit or scope of the claimed subject matter. Additionally, sensors external to the vehicle may be employed to provide or supplement any of the sensor data described hereinabove. Alternatively, machine learning algorithms or other AI systems may be used to estimate variables from sparse, noisy, or entwined data streams without departing from the spirit of the present disclosure.

Still other embodiments are contemplated. It is intended that all matter contained in the above description and shown in the accompanying drawings shall be interpreted as illustrative only of particular embodiments and not limiting. Changes in detail or structure may be made without departing from the basic elements of the subject matter as defined in the following claims.

What is claimed is:

1. A computer-implemented method to predict trip energy required for electric vehicles, the method comprising:
obtaining, via a user interface, a destination location of an electric vehicle; and
calculating, using a machine learning (“ML”) model, energy required for the electric vehicle to arrive at the destination location,
wherein the ML model comprises:
an energy consumption model that predicts, based upon vehicle input features, variability of vehicle energy consumption while being driven to the destination location; and
an air-conditioning (“AC”) model that predicts variability of an AC system of the electric vehicle while being driven to the destination location.

2. The computer-implemented method as defined in claim 1, wherein the ML model utilizes a recurrent neural network (“RNN”) to predict the energy required to arrive at the destination location.

3. The computer-implemented method as defined in claim 2, wherein the RNN is trained using mile-based data aggregated over different link distances, the link distances being road segments.

4. The computer-implemented method as defined in claim 3, wherein the link distances are road segments with at least one of a constant traffic attribute and constant road attribute.

5. The computer-implemented method as defined in claim 3, wherein the ML model utilizes the RNN to determine a temporal relationship between the road segments.

6. The computer-implemented method as defined in claim 1, wherein the ML model is derived from real-world driving data of electric vehicle users obtained during previous trips.

7. The computer-implemented method as defined in claim 6, wherein the real-world driving data captures various traffic, road and weather conditions.

8. The computer-implemented method as defined in claim 1, wherein the vehicle input features account for at least one of a speed limit, traffic speed, road elevation, road conditions and wind conditions along a route to the destination location.

9. The computer-implemented method as defined in claim 1, wherein the AC model accounts for variation in ambient temperature along a route to the destination location.

10. A system to predict trip energy required for electric vehicles, the system comprising:
a processor having a memory and configured to perform operations comprising:
obtaining, via a user interface, a destination location of an electric vehicle; and
calculating, using a machine learning (“ML”) model, energy required for the electric vehicle to arrive at the destination location,
wherein the ML model comprises:
an energy consumption model that predicts, based upon vehicle input features, variability of vehicle energy consumption while being driven to the destination location; and
an air-conditioning (“AC”) model that predicts variability of an AC system of the electric vehicle while being driven to the destination location.

11. The system as defined in claim 10, wherein the ML model utilizes a recurrent neural network (“RNN”) to predict the energy required to arrive at the destination location.

12. The system as defined in claim 11, wherein the RNN is trained using mile-based data aggregated over different link distances, the link distances being road segments.

13. The system as defined in claim 10, wherein the ML model is derived from real-world driving data of electric vehicle users obtained during previous trips.

14. The system as defined in claim 10, wherein the vehicle input features account for at least one of a speed limit, traffic speed, road elevation, road conditions and wind conditions along a route to the destination location.

15. The system as defined in claim 10, wherein the AC model accounts for variation in ambient temperature along a route to the destination location.

16. A non-transitory computer-readable storage medium storing instructions that, when executed by a computing system, cause the computing system to perform operations comprising:
obtaining, via a user interface, a destination location of an electric vehicle; and
calculating, using a machine learning (“ML”) model, energy required for the electric vehicle to arrive at the destination location,
wherein the ML model comprises:
an energy consumption model that predicts, based upon vehicle input features, variability of vehicle energy consumption while being driven to the destination location; and
an air-conditioning (“AC”) model that predicts variability of an AC system of the electric vehicle while being driven to the destination location.

17. The computer-readable storage medium as defined in claim 16, wherein the ML model utilizes a recurrent neural network (“RNN”) to predict the energy required to arrive at the destination location.

18. The computer-readable storage medium as defined in claim 16, wherein the RNN is trained using mile-based data aggregated over different link distances, the link distances being road segments.

19. The computer-readable storage medium as defined in claim 16, wherein the ML model is derived from real-world driving data of electric vehicle users obtained during previous trips.

20. The computer-readable storage medium as defined in claim 16, wherein at least one of:
the vehicle input features account for at least one of a speed limit, traffic speed, road elevation, road conditions and wind conditions along a route to the destination location; or
the AC model accounts for an ambient temperature along a route to the destination location.
